(19) United States
(12) Patent Application Publication
(10) Pub. No.: US 2019/0070064 A1
(43) Pub. Date: Mar. 7, 2019

(54) OBJECT DETECTION, ANALYSIS, AND ALERT SYSTEM FOR USE IN PROVIDING VISUAL INFORMATION TO THE BLIND

(71) Applicant: WICAB, INC., Middleton, WI (US)

(72) Inventors: Richard Hogle, Middleton, WI (US); Robert Beckman, Middleton, WI (US)

(21) Appl. No.: 16/082,472

(22) PCT Filed: Mar. 7, 2017
(86) PCT No.: PCT/US17/21189

§ 371 Date: Sep. 5, 2018

Related U.S. Application Data
(60) Provisional application No. 62/304,785, filed on Mar. 7, 2016.
(60) Provisional application No. 62/338,271, filed on May 18, 2016.

(30) Foreign Application Priority Data
Jul. 20, 2016 (CN) 201610575980.7
Jul. 20, 2016 (CN) 2016105770925.9

(51) Int. Cl. A61H 3/06; G06K 9/00

(52) U.S. Cl. CPC A61H 3/061; A61H 2003/063; G06K 9/00637; G06K 9/00671

(57) ABSTRACT

A portable, closed-loop system of capture, analysis, and feedback uses a headset containing a small unobtrusive camera and a control computer that communicates wirelessly with a wireless network and/or remote platform. The headset may also contain user controls, an audio feedback component, a battery, interconnection circuitry, cables, and connections for an intraoral device. The camera component of the headset captures images during an activity to be analyzed, such as walking or viewing a room, and sends data (e.g., visual data) to the controller. The controller transmits the data to a database on the remote platform that includes software that instantly analyzes the image information represented in the data, then provides immediate feedback to the headset. The controller may independently process the data.

This invention was made with government support under DM090217 and DM130076 by the Department of Defense (DoD) Defense Medical Research and Development Program (DMRDP). The government has certain rights in the invention.

### FIELD OF THE INVENTION

The present invention relates generally to methods and apparatus for providing visual information to a visually impaired or blind person. More specifically, the present invention relates to methods and apparatus designed to provide a completely blind person the ability to detect and identify landmarks and to navigate within their surroundings. The apparatus includes a portable, closed-loop system of capture, analysis, and feedback that uses a headset containing an unobtrusive camera and a control computer that communicates wirelessly with a wireless network and/or remote platform. The camera component of the headset captures images during an activity to be analyzed, such as walking or viewing a room, and sends data (e.g., visual data) to the controller. The controller transmits the data to a database on the remote platform that includes software that analyzes the image information represented in the data, then provides feedback to the headset. The controller may independently process the data. The headset provides feedback to the user in the form of haptic means (e.g., electrotactile stimulation of the user's tongue via an attached intraoral device) and/or audible means (e.g., via a speaker).

### BACKGROUND OF THE INVENTION

The American Foundation for The Blind (AFB) has estimated that the United States is currently home to about 1.3 Million legally blind people. This number is a tiny fraction of the total population of legally blind people worldwide estimated to be about 40 million. Nearly half of the legally blind, worldwide population of blind people live in China.

Blind subjects have traditionally relied on canes to guide them around (e.g., when walking down a street or hallway, or when navigating a room or store). A conventional mobility cane, however, only provides a very limited amount of information about a user's surrounding environment, usually about the objects that may be physically touched by the cane.

Other devices have been developed to provide a blind or visually impaired person information about his or her surrounding environment beyond the physical reach of a conventional cane. For example, acoustic canes provide information through sound feedback (echolocation). When an acoustic cane is used, it sends out audio signals that reflect or echo from objects within the user's surrounding environment. The user interprets the echoes to decipher the layout of the environment. Other devices send out light signals that reflect from objects surrounding the user. The reflections are then converted into audible signals such as a click or a variably pitched beep to convey information about the surrounding objects back to the user.

U.S. patent application Ser. No. 10/519,483 (Publication Number US 2006/0098089 A1) discloses an apparatus including electro-optical devices to detect and identify objects. A control unit is used to receive and process information from the devices. A vocal representation unit is then used to receive instructions from the control unit for purpose of audibly describing the objects to the user.

U.S. patent application Ser. No. 12/354,266 (Publication Number US 2010/0177179) discloses an apparatus including components similar to those in U.S. patent application Ser. No. 10/519,483, but also including a monitor coupled to the apparatus on which the user can view their surrounding

U.S. patent application Ser. No. 11/925,393 (Publication Number US 2009/0312817) discloses a vision assistance and/or augmentation device that provides visual imagery on a user's tongue using electrotactile stimulation.

Such devices, however, have significant limitations in that they provide little to no information to profoundly blind users regarding the user's distal environment. For example, devices relying on a monitor to provide information regarding the surrounding environment to a blind person provide no useable information to the person. Also, the use of audio signals alone to convey information regarding surrounding environment to a user are ill suited for noisy environments such as heavily trafficked streets or for deaf-blind individuals who are incapable of hearing the audio signals. Additionally, for a profoundly blind user, these and other existing devices are not capable of identifying landmarks (e.g., such as signs or navigational cues) for the blind person in the persons environment that are beyond the distance that can be scanned by and touched with a cane.

### SUMMARY OF THE INVENTION

The present invention solves the problems in the prior art approaches by offering an apparatus and method that provides to a blind user the ability to scan her or his environment, both immediate and distant, to both detect and identify landmarks (e.g., signs or other navigational cues) as well as the ability to see the environment via electrotactile stimulation of the user's tongue.

Accordingly, in one embodiment, the present invention relates generally to an apparatus (e.g., vision assistance device (VAD)) and a method for providing visual information to a visually impaired or blind person. More specifically, the present invention relates to an apparatus and a method designed to provide a completely blind person the ability to detect and identify landmarks and to navigate within their surroundings. The apparatus includes a portable, closed-loop system of capture, analysis, and feedback that uses a headset containing an unobtrusive camera and a control computer that communicates wirelessly with a wireless network and/or remote platform. The camera component of the headset captures images during an activity to be analyzed, such as walking or viewing a room, and sends data (e.g., visual data) to the controller. The controller transmits the data to a database on the remote platform that includes software that analyzes (e.g., instantly analyzes) the image information represented in the data, then provides feedback (e.g., immediate feedback) to the headset. The headset controller may independently process the data. The headset provides feedback to the user in the form of haptic means (e.g., electrotactile stimulation of the user's tongue via an attached intraoral device) and/or audible means (e.g., via a speaker).

Thus, in one embodiment, it is an object of the present invention to provide methods and apparatus to provide blind people the ability to detect and identify landmarks in their surroundings. It is a further object to provide increased versatility, efficiency, adaptability, and/or economy in an apparatus comprising a portable, closed-loop system of capture, analysis, and feedback that uses a headset containing an unobtrusive camera and a control computer (e.g., comprising a processor (e.g., that communicates wirelessly with a wireless network and/or remote platform for landmark detection and identification)).

It is a further object of the present invention to provide methods and apparatus (e.g., VAD comprising a controller/processor that analyzes data and/or that transmits data to a remote platform containing a processor, database and analysis means) for selecting an algorithm from a plurality of object detection, object analysis, object identification, edge enhancement, highlighting, and shadow removal algorithms to be applied to images (e.g., captured by the VAD) by the apparatus and/or processor component thereof (e.g., modifying the image using one or more algorithms substantially in real time, and displaying the modified image on a display (e.g., Intra-Oral Device (IOD) worn by an individual)). In one embodiment, a processor of the VAD and/or remote platform applies an algorithm for detecting, analyzing, and/or identifying objects within a camera's field of view worn by a blind person. In another embodiment, a processor of the VAD and/or remote platform applies an algorithm for edge enhancement of objects within a camera's field of view worn by a blind person. In still another embodiment, a processor of the VAD and/or remote platform applies an algorithm for highlighting an objects within a camera's field of view worn by a blind person. In another embodiment, a processor of the VAD and/or remote platform applies an algorithm for shadow removal from within a camera's field of view worn by a blind person. In another embodiment, a processor of the VAD and/or remote platform applies an algorithm for analyzing transmitted data/information within a database on a platform remote from the headset controller. In a further embodiment, a processor of the VAD and/or remote platform applies an algorithm that generates feedback information regarding the analyzed transmitted data/information, with the feedback information transmitted (e.g., over a wireless network) to the VAD for delivery to the blind person. The invention is not limited by the means by which the feedback information is delivered to the blind person. Exemplary means include delivery of the feedback information (e.g., containing visual information) to the blind person via haptic (e.g., electrotactile stimulation of person's tongue) as well as audible (e.g., via speaker, headphone, or bone conduction) means.

In one embodiment, the present invention provides methods and apparatus to detect, identify, and highlight a landmark within a blind user's environment (e.g., as a means of leading the user to the landmark (e.g., sign (e.g., exit sign, bathroom sign, crosswalk sign, or other sign commonly used to navigate an environment))). The invention is not limited to any particular means of highlighting the landmark. Several non-limiting examples include a method and apparatus for applying an algorithm for highlighting the landmark on the user's tongue with electrotactile stimulation, as well as a method and apparatus for applying an algorithm for highlighting the landmark audibly to the user as the user scans the environment using the camera to provide visual information on the user's tongue with electrotactile stimulation. Accordingly, in one embodiment, a processor of the VAD and/or remote platform applies an algorithm for highlighting an object (e.g., a landmark) for a user.

In one embodiment, the invention provides an apparatus and method for aiding a blind person to detect, identify, and/or move towards a landmark (e.g., while navigating around, over, and/or through obstacles or structures within the person's environment). In one embodiment, the apparatus includes a headset containing an unobtrusive camera and a control computer that communicates wirelessly with a wireless network and/or remote platform, user controls, an audio feedback component, a battery, interconnection circuitry, cables, and connections for an intraoral device. In one embodiment, the camera component of the headset captures visual information of the environment during a user activity to be analyzed, such as walking or viewing a room, and sends the visual information to the controller, whereby the controller transmits the visual information data (e.g., all or a component of the total visual information captured by the camera) to a database on the remote platform that includes algorithms and/or software that analyzes the image information represented in the visual information data, that then provides feedback regarding the visual information data to the headset, that in turn provides the feedback to the blind user (e.g., via haptic (e.g., electrotactile stimulation of person's tongue) and/or audible (e.g., via speaker, headphone, or bone conduction) means).

In one embodiment, logic flow, an algorithm, and/or software is used to transmit images from the VAD controller to a remote platform (e.g., engaging algorithms executing on a remote platform (e.g., to analyze and/or modify (e.g., enhance, highlight, and/or remove shadows in) the images and to return the images (e.g., modified images) to the VAD (e.g., to the headset for presentation to the intraoral device))). In one embodiment, data derived from a database accessed by a remote platform is integrated with images transmitted by the controller and then retransmitted back to the controller. Exemplary databases include, but are not limited to, landmark or GPS data which is overlayed (added to) the source image such that the user is alerted to a special feature in the image scene.

In another embodiment, a logic flow, algorithm, and/or software is used to receive images from a remote platform that permits presentation of stimulation patterns based on arbitrary images (for example, images of alphanumeric characters, animals, scenery, hand sketches, etc) generated and/or delivered by the remote platform. The arbitrary images may be derived from a database of images used for training purposes (e.g., to train the user on the shape of an object). In another embodiment, the arbitrary images may be derived from images of artwork created and/or stored on the remote platform, or in a database accessed by the remote platform. The arbitrary images may be derived from stored or live video streams from TV, social media, or any other means through which video streams are viewed and/or transmitted.

It is a further object of the invention to provide methods and apparatus to detect and remove shadows from visual information captured by a camera. In one embodiment, shadow detection and removal from visual information captured by the camera (e.g., the digital image stream) includes processing of the visual information by the headset controller and/or the remote platform (e.g., using a processor, algorithm, and/or other computer component) to remove shadows from the visual information (e.g., prior to providing feedback regarding the visual information captured by the camera (e.g., the digital image stream) to a blind person via the headset).

In one embodiment, the invention provides a method for a blind person to detect, identify, and/or move towards a landmark (e.g., while navigating around, over, and/or through obstacles or structures within the person's environment), including the steps of receiving visual information of the user's environment, transmitting visual information data (e.g., all or a component of the total visual information captured by the camera) to a remote platform (e.g., to a database on a remote platform), analysis of the visual information data on the remote platform, and sending feedback regarding the visual information data to the user from the remote platform thereby enabling the user to detect, identify, and/or move towards the landmark (e.g., while navigating around, over, and/or through obstacles or structures within the person's environment).

In one embodiment, the present invention provides methods and apparatus to detect, identify, and/or highlight a landmark within a blind user's environment (e.g., as a means of leading the user to the landmark (e.g., sign (e.g., exit sign, bathroom sign, crosswalk sign, or other sign commonly used to navigate an environment)). In one embodiment, the apparatus includes a headset containing a camera and a control computer that communicates wirelessly with a wireless network and/or remote platform, and a remote platform comprising a processor component, a memory component, and a software component, wherein visual information obtained from the camera is processed on the remote platform. In one embodiment, the remote platform comprises an algorithm to detect, identify, and/or highlight a landmark present in the visual information. In another embodiment, the remote platform comprises an algorithm to detect and reduce and/or eliminate shadows in the visual information. In yet another embodiment, the remote platform comprises an algorithm to detect objects in the visual information. In one embodiment, the apparatus includes means for delivering information regarding a landmark, a shadow, and/or an object to the blind user.

In one embodiment, a VAD captures luminance data from digital images and translates that data to stimulation patterns presented to the tongue. The stimulation patterns are generated by an array of electrodes in which each electrode has an applied voltage directly related to the magnitude of the luminance data at a corresponding image location. Thus, in one embodiment, wherein each electrode has an applied voltage directly related to the magnitude of the luminance data at a corresponding image location, equal weighting is given to objects near and far (e.g., so that when the 3-dimensional world (e.g., visual field of view) is mapped to a 2-dimensional stimulation array (e.g., IOD), a blind user experiences stimulation cluttered patterns. Due to the discovery that cluttered stimulation pattern presents a challenge to the user when trying to interpret what the patterns mean made during development of embodiments of the invention, in one embodiment, an edge detection algorithm is utilized (e.g., to present only the detected edges in the stimulation pattern (e.g., thereby reducing the clutter experienced by the blind user (e.g., thereby increasing usefulness of the device))). In another embodiment, native visual information (e.g., images) is presented with enhanced edges (e.g., the edges of an object within the field of view is enhanced using an edge enhancement algorithm) by modifying the stimulation pattern (e.g., thereby providing context of the object to the user).

It is a further object of the invention to provide methods and apparatus to detect range and distance information of objects in visual information captured by a camera. In one embodiment, range and distance information of objects in visual information captured by the camera (e.g., the digital image stream) includes processing of the visual information by the headset controller and/or the remote platform (e.g., using a processor, algorithm, and/or other computer component) to compute range and distance information of object in the visual information (e.g., prior to providing feedback regarding the visual information captured by the camera (e.g., the digital image stream) to a blind person via the headset).

It is a further object of the invention to provide methods and apparatus to detect color and/or contrast information of objects in visual information captured by a camera. In one embodiment, color and/or contrast information of objects in visual information captured by the camera (e.g., the digital image stream) includes processing of the visual information by the headset controller and/or the remote platform (e.g., using a processor, algorithm, and/or other computer component) to compute color and/or contrast information of object in the visual information (e.g., prior to providing feedback regarding the visual information captured by the camera (e.g., the digital image stream) to a blind person via the headset).

It is a further object of the invention to provide methods and apparatus to detect gesture based instructions in visual information captured by a camera. In one embodiment, gesture based instructions captured by the camera (e.g., the digital image stream) includes processing of the visual information by the headset controller and/or the remote platform (e.g., using a processor, algorithm, and/or other computer component) to detect gesture based instructions in the visual information.

These objects, and others not specified hereinabove, are achieved by an exemplary embodiment of the present invention, wherein a system of the present invention is designed to aid blind people to detect, identify, and/or highlight a landmark within a blind user's environment (e.g., as a means of leading the user to the landmark (e.g., sign (e.g., exit sign, bathroom sign, crosswalk sign, or other sign commonly used to navigate an environment)). An apparatus of the present invention is compact and light weight, and can be mounted on head of the blind person. The invention, together with additional features and advantages thereof, may be best understood by reference to the following description taken in conjunction with the accompanying illustrative drawings.

### DESCRIPTION OF DRAWINGS

FIG. 1 shows a non-limiting example of a vision assistance device (VAD) for blind persons of the present invention.

FIGS. 2A-2G show additional drawings of a non-limiting example of a vision VAD of the present invention.

FIGS. 2H-2N show a device incorporating the VAD of the present invention.

FIG. 3 shows one exemplary VAD of the invention including a number of interconnected subsystems containing Printed Circuit Assemblies (PCAs) interconnected by cables.

FIGS. 4A and 4B show exemplary control buttons implemented as a Membrane Switch Assembly according to an embodiment of the invention.

FIG. 5 shows a Sensor Subsystem located in a front section of the headset frame of a VAD according to an embodiment of the invention.

FIG. 6 shows a VAD Battery Housing connected to the VAD Headset with a Power Cable according to an embodiment of the invention.

FIG. 7 shows an exemplary VAD of the invention.

FIG. 8 shows exemplary User Controls integrated into a VAD according to an embodiment of the invention.

FIG. 9 shows what a sighted companion would see regarding image and status information obtained by a user of a VAD of the invention.

FIG. 10 shows sample Exit sign detections. (A) Successful detection. (B) Rectangle shows a false negative (missed detection), indicating a candidate detected by the first (Adaboost) classifier stage that was incorrectly rejected by the second (SVM) classifier stage. (C) False positive (spurious) detection shows a region with texture from building façade.

FIG. 11 shows sample Restroom sign detections. (A) Successful detection. (B) Successful detection. (C) The two rectangles show two false negatives, that is, two Restroom icons that were not detected.

FIG. 12 shows receiver operating characteristics (precision vs recall) curve for Restroom sign detector: curve shows results without tracking, X shows result with tracking. Tracking increases the recall with only a modest decrease in precision.

FIG. 13 shows receiver operating characteristics (precision vs recall) curve for Exit sign detector. Curve shows results without tracking, X shows result with tracking.

FIG. 14 depicts an exemplary process flow relating to detecting, analyzing, and/or identifying an object captured by a camera component of a vision assistance device (VAD) according to an embodiment of the invention.

FIG. 15 depicts an exemplary process flow relating to edge enhancement of objects within the visual field captured by a camera component of a VAD according to an embodiment of the invention.

FIG. 16 depicts an exemplary process flow relating to highlighting an object within the visual field captured by a camera component of a VAD according to an embodiment of the invention.

FIG. 17 depicts an exemplary process flow relating to shadow removal from within a camera's field of view captured by a camera component of a VAD according to an embodiment of the invention.

FIG. 18 depicts an exemplary processing of visual information according to predetermined logic of a logic tree using a VAD, an algorithm for detecting, analyzing, and/or identifying an object captured by the VAD, and a database according to an embodiment of the invention.

FIG. 19 depicts an exemplary processing of visual information according to predetermined logic of a logic tree using a remote platform, a VAD, an algorithm for detecting, analyzing, and/or identifying an object captured by the VAD, and a database according to an embodiment of the invention.

FIG. 20 depicts an exemplary processing of visual information including providing feedback information to a user according to predetermined logic of a logic tree using a remote platform, a VAD, an algorithm for detecting, analyzing, and/or identifying an object captured by the VAD, and a database according to an embodiment of the invention.

FIG. 21 depicts an exemplary processing of visual information including providing feedback information to a user according to predetermined logic of a logic tree using a remote platform, a VAD, an algorithm for detecting, analyzing, and/or identifying an object captured by the VAD, an algorithm for highlighting an object, and a database according to an embodiment of the invention.

FIG. 22 depicts an exemplary process flow relating to identifying landmark coordinates and adjusting camera parameters to zoom to and improve (e.g., increase) image resolution of a known (e.g., saved) landmark area according to an embodiment of the invention.

### DEFINITIONS

To facilitate an understanding of the present invention, a number of terms and phrases are defined below:

As used herein, the term “amplifier” refers to a device that produces an electrical output that is a function of the corresponding electrical input parameter, and increases the magnitude of the input by means of energy drawn from an external source (i.e., it introduces gain). “Amplification” refers to the reproduction of an electrical signal by an electronic device, usually at an increased intensity. “Amplification means” refers to the use of an amplifier to amplify a signal. It is intended that the amplification means also includes means to process and/or filter the signal.

As used herein, the term “receiver” refers to the part of a system that converts transmitted waves into a desired form of output. The range of frequencies over which a receiver operates with a selected performance (i.e., a known level of sensitivity) is the “bandwidth” of the receiver.

As used herein, the term “transducer” refers to any device that converts a non-electrical parameter (e.g., sound, pressure or light), into electrical signals or vice versa.

As used herein, the terms “stimulator” and “actuator” are used herein to refer to components of a device that impart a stimulus (e.g., vibrotactile, electrotactile, thermal, etc.) to tissue of a subject. When referenced herein, the term stimulator provides an example of a transducer. Unless described to the contrary, embodiments described herein that utilize stimulators or actuators may also employ other forms of transducers.

The term “circuit” as used herein, refers to the complete path of an electric current.

As used herein, the term “resistor” refers to an electronic device that possesses resistance and is selected for this use. It is intended that the term encompass all types of resistors, including but not limited to, fixed-value or adjustable, carbon, wire-wound, and film resistors. The term “resistance” (R; ohm) refers to the tendency of a material to resist the passage of an electric current, and to convert electrical energy into heat energy.

The term “magnet” refers to a body (e.g., iron, steel or alloy) having the property of attracting iron and producing a magnetic field external to itself, and when freely suspended, of pointing to the magnetic poles of the Earth.

As used herein, the term “magnetic field” refers to the area surrounding a magnet in which magnetic forces may be detected.

As used herein, the term “electrode” refers to a conductor used to establish electrical contact with a nonmetallic part of a circuit, in particular, part of a biological system (e.g., human skin on tongue).

The term “housing” refers to the structure encasing or enclosing at least one component of the devices of the present invention. In preferred embodiments, the “housing” is produced from a “biocompatible” material. In some embodiments, the housing comprises at least one hermetic feedthrough through which leads extend from the component inside the housing to a position outside the housing.

As used herein, the term “biocompatible” refers to any substance or compound that has minimal (i.e., no significant difference is seen compared to a control) to no irritant or immunological effect on the surrounding tissue. It is also intended that the term be applied in reference to the substances or compounds utilized in order to minimize or to avoid an immunologic reaction to the housing or other aspects of the invention. Particularly preferred biocompatible materials include, but are not limited to titanium, gold, platinum, sapphire, stainless steel, plastic, and ceramics.

As used herein, the term “hermetically sealed” refers to a device or object that is sealed in a manner that liquids or gases located outside the device are prevented from entering the interior of the device, to at least some degree. “Completely hermetically sealed” refers to a device or object that is sealed in a manner such that no detectable liquid or gas located outside the device enters the interior of the device. It is intended that the sealing be accomplished by a variety of means, including but not limited to mechanical, glue or sealants, etc. In particularly preferred embodiments, the hermetically sealed device is made so that it is completely leak-proof (i.e., no liquid or gas is allowed to enter the interior of the device at all).

As used herein the term “processor” refers to a device that is able to read a program from a computer memory (e.g., ROM or other computer memory) and perform a set of steps according to the program. Processor may include non-algorithmic signal processing components (e.g., for analog signal processing).

As used herein, the terms “memory component,” “computer memory” and “computer memory device” refer to any storage media readable by a computer processor. Examples of computer memory include, but are not limited to, RAM, ROM, computer chips, digital video disc (DVDs), compact discs (CDs), hard disk drives (HDD), and magnetic tape.

As used herein, the term “remote platform” refers to any remote computer, phone, tablet, personal computer, or other device containing a processor and memory component (e.g., for storing a database) that is separate from the headset controller of the present invention.

As used herein, the term “computer readable medium” refers to any device or system for storing and providing information (e.g., data and instructions) to a computer processor. Examples of computer readable media include, but are not limited to, DVDs, CDs, hard disk drives, magnetic tape, flash memory, and servers for streaming media over networks.

As used herein the terms “multimedia information” and “media information” are used interchangeably to refer to information (e.g., digitized and analog information) encoding or representing audio, video, and/or text. Multimedia information may further carry information not corresponding to audio or video. Multimedia information may be transmitted from one location or device to a second location or device by methods including, but not limited to, electrical, optical, and satellite transmission, and the like.

As used herein, the term “Internet” refers to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc.). The term is also intended to encompass non-public networks such as private (e.g., corporate) Intranets.

As used herein the term “security protocol” refers to an electronic security system (e.g., hardware and/or software) to limit access to processor, memory, etc. to specific users authorized to access the processor. For example, a security protocol may comprise a software program that locks out one or more functions of a processor until an appropriate password is entered.

As used herein the term “resource manager” refers to a system that optimizes the performance of a processor or another system. For example a resource manager may be configured to monitor the performance of a processor or software application and manage data and processor allocation, perform component failure recoveries, optimize the receipt and transmission of data, and the like. In some embodiments, the resource manager comprises a software program provided on a computer system of the present invention.

As used herein the term “in electronic communication” refers to electrical devices (e.g., computers, processors, communications equipment) that are configured to communicate with one another through direct or indirect signaling. For example, a conference bridge that is connected to a processor through a cable or wire, such that information can pass between the conference bridge and the processor, are in electronic communication with one another. Likewise, a computer configured to transmit (e.g., through cables, wires, infrared signals, telephone lines, etc.) information to another computer or device, is in electronic communication with the other computer or device.

As used herein the term “transmitting” refers to the movement of information (e.g., data) from one location to another (e.g., from one device to another) using any suitable means (e.g., wireless communications (e.g., WIFI, the internet, the cloud, etc.) as well as wired communications).

As used herein, the term “electrotactile” refers to a means whereby sensory channels (e.g., nerves) responsible for sensory functions are stimulated by an electric current. In some embodiments, the term refers to a means by which sensory channels (e.g., nerves) responsible for human touch (and/or taste) perception are stimulated by an electric current (applied via surface (or implanted) electrodes). The term electrotactile may be used interchangeably with the terms “electrocutaneous” and “electrodermal.”

### DETAILED DESCRIPTION OF THE INVENTION

The present invention solves the problems in the prior art approaches by offering methods and apparatus that provide to a blind user the ability to scan her or his environment, both immediate and distant, to detect and identify landmarks (e.g., signs or other navigational cues) as well as the ability to see the environment via electrotactile stimulation of the user's tongue.

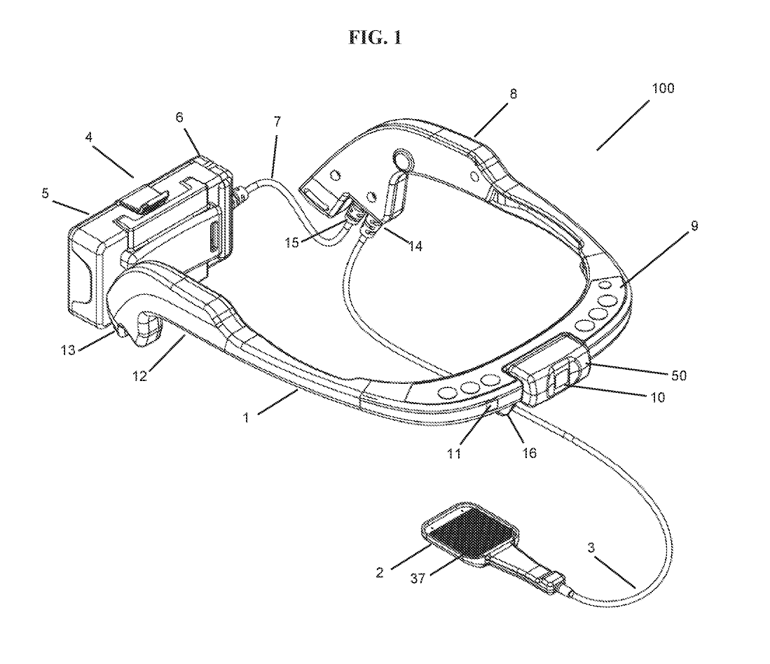

Accordingly, in one embodiment, the present invention relates generally to an apparatus and a method for providing visual information to a visually impaired or blind person. More specifically, the present invention relates to an apparatus (e.g., vision assistance device (VAD) 100, shown in FIGS. 1, 2H-2N, 6, and 7) and a method designed to provide a completely blind person the ability to detect and identify landmarks and to navigate within their surroundings. The apparatus includes a portable, closed-loop system of capture, analysis, and feedback that uses a headset 1 containing an unobtrusive camera 10 and a control computer 8 that communicates wirelessly with a wireless network and/or remote platform. The camera component 10 of the headset 1 captures images during an activity to be analyzed, such as walking or viewing a room, and sends data (e.g., visual data) to the controller 8. The controller 8 transmits the data to a database on the remote platform that includes software that instantly analyzes the image information represented in the data, then provides immediate feedback to the headset 1. The controller 8 may independently process the data. The headset 1 provides the feedback to the user in the form of electrotactile stimulation of the user's tongue via an attached intraoral device 2.

In one embodiment, a vision assistance device 100 (VAD, also referred to herein as “V200” or “BRAINPORT V200”) of the invention translates images of objects captured by a digital camera 10 into electrotactile signals that are presented to the user's tongue. Users interpret the electrotactile signals to perceive visual information including, but not limited to, shape, size, location and motion of objects. In a further embodiment, a VAD 100 of the invention contains components that enable wireless connection to/communication with one or more remote platforms (e.g., for the exchange of image data, status, and/or control information). This functionality significantly extends the capability of a VAD 100 of the invention in comparison to conventional devices (e.g., by taking advantage of computer processing power of the one or more remote platforms (e.g., including access to the Internet and related services)).

In some embodiments, a VAD 100 of the invention augments other vision assistive technology (e.g., a cane or guide dog). In other embodiments, a VAD 100 of the invention completely replaces other vision assistive technology (e.g., a cane or guide dog).

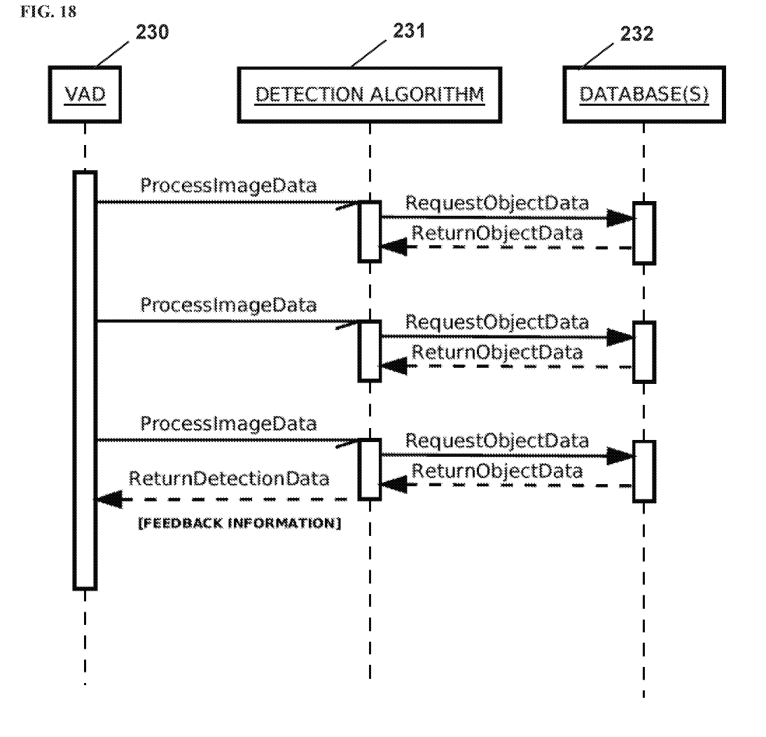

Non-limiting examples of a vision assistance device (VAD) 100 and various components therefore for blind persons of the present invention are shown in FIGS. 1-2 and 4-8. In one embodiment, a VAD 100 of the invention may comprise a fully wearable, battery operated device with no physical connections to external equipment (e.g., during normal operation). The device is intended for portable use. As shown in FIG. 1, a VAD 100 of the invention can include a headset 1, an Intra-Oral Device (IOD) 2, a battery housing 4, and/or a battery charger. The headset 1 provides the image input and output functions of the device. The IOD 2 contains stimulating electrodes (e.g., arranged in an array (e.g., a 20 row×20 column array, with several electrodes removed on two edges in order to better conform to the tongue)). The IOD 2 can be placed on a user's tongue with the electrodes 37 in contact with the tongue. Stimulation patterns derived from the camera images (or other sources, such as feedback data received via a structured data streaming network protocol from a remote platform (See, e.g., FIGS. 18, 20, and 21) are output to the array. The user feels these patterns and interprets them as visual information (e.g., thereby perceiving information about the scene and environment before and around the user).

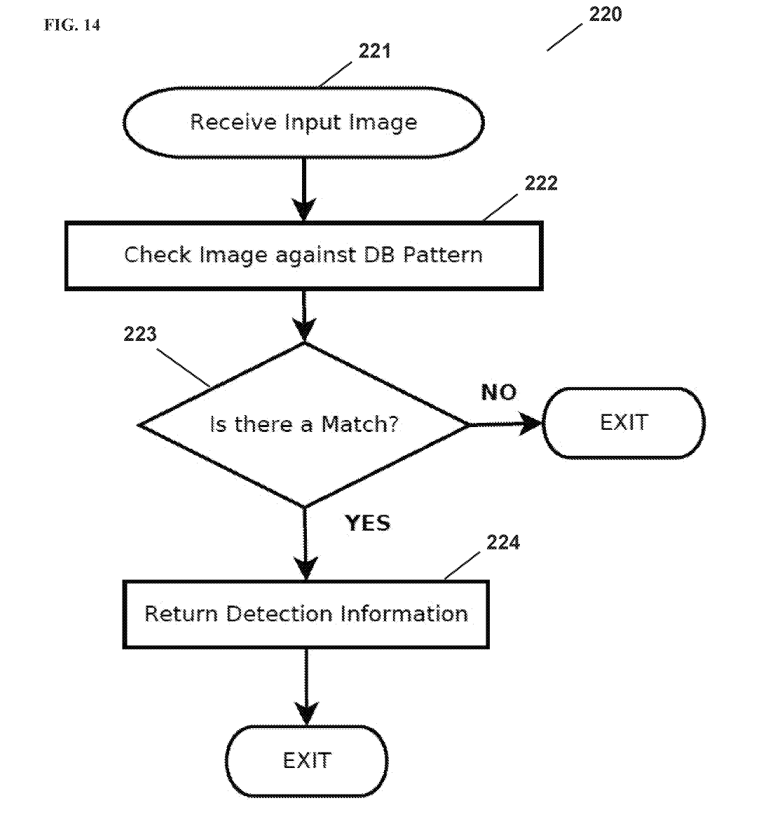

For example, in one embodiment, the use of logic flow, an algorithm, and/or software described herein (e.g., in FIGS. 14-21) to transmit images from the controller to a remote platform allows algorithms executing on those platforms to analyze and modify (e.g., enhance, highlight, and/or remove shadows in) the images and return the images (e.g., modified images) to the headset for presentation to the intraoral device. For instance, data derived from databases accessed by a remote platform can be integrated with images transmitted by the controller and then retransmitted back to the controller. Exemplary databases may include, but are not limited to, landmark or GPS data which is overlayed (added to) the source image such that the user is alerted to a special feature in the image scene.

In addition, use of a logic flow, algorithm, and/or software to receive images from a remote platform allows for the presentation of stimulation patterns based on arbitrary images (for example, images of alphanumeric characters, animals, scenery, hand sketches, etc.) generated and/or delivered by the remote platform. The arbitrary images may be derived from a database of images used for training purposes (e.g., to train the user on the shape of an object). In another embodiment, the arbitrary images may be derived from images of artwork created and/or stored on the remote platform, or in a database accessed by the remote platform (e.g., “cloud-based” database). The arbitrary images may be derived from stored or live video streams from TV, social media, or any other means through which video streams are viewed and/or transmitted. The arbitrary images can be used to enhance the camera image, by augmenting the camera image with information stored in the database (e.g., adding landmark indications). Furthermore, software and/or algorithms can be used to receive images from a remote platform (Streaming Software) that allows for the presentation of stimulation patterns based on arbitrary images generated and/or delivered by the remote platform. The arbitrary images can be derived from a database of images used for training purposes, to train the user on the shape of objects, for example.

The invention is not limited by the type of battery 5. In one embodiment, the battery housing 4 holds a lithium-polymer rechargeable battery 5 (e.g., that can be removed or replaced by a user). The battery housing 4 is attached to the headset via an adjustable strap and is can be worn behind the head. This allows the user to have completely hands-free operation of the VAD 100.

The headset 1 can include a camera unit 10, user controls 9, control computer (controller, e.g., computer-on-module (COM) or system on module) 8, interconnection circuitry, and associated cables (e.g., all contained within a housing similar to the size and shape of an eyeglasses frame). Simple head motion by the user directs the view of the camera 10 to a scene of interest (e.g., to scan the environment laterally and/or horizontally). The camera 10 captures the viewed scene as a digital image with the image being forwarded to the controller 8 (e.g., for processing and/or relay to a remote platform). The electrode array on the IOD 2 presents stimulation patterns representative of the camera image to the user's tongue. While the invention is not limited by the number of electrodes present on the IOD 2, in one embodiment, the IOD 2 contains 396 electrodes arranged in a 20×20 grid 37 (3 electrodes on each of the front corner are not installed so that the corners can be rounded). The electrodes are placed on the top surface of the tongue during use. In one embodiment as shown in FIG. 1, the IOD 2 is tethered to the headset with a flexible cable 3 that allows for easy repositioning of the IOD 2 on the tongue and removal of the IOD 2 from the oral cavity. In another embodiment, the IOD 2 is wirelessly connected to the headset 1. User controls 9 and feedback are located on the headset 1 (See, e.g., FIG. 1, button membrane switch assembly 9). The invention is not limited by the means of providing haptic (e.g., electrical) stimulation to a user's tongue. In one embodiment, a device described in U.S. patent application Ser. No. 11/925,393 (Publication Number US 2009/0312817), hereby incorporated by reference in its entirety, is used.

Additional features may be incorporated into the headset 1 (See, e.g., FIG. 1). These features include audio feedback means (e.g., audio speaker 12, audio connection port 13), wireless (e.g., WIFI) System On Module (SOM) 8, light sensor 27, proximity sensor 24, motion tracking unit (MTU) including a 3-axis accelerometer, 3-axis gyroscope, a 3-axis magnemeter, and temperature sensor, as well as printed circuit assemblies for each component. In one embodiment, the headset 1 also includes a connection or port for an IOD cable 14, a connection or port for a power cord 15, and/or a nose piece 16 for adaptation and/or fit of the headset 1 to a user's face.

In one embodiment, using simple head motions, a user points the camera 10 towards a scene of interest. The camera 10 captures light reflected by the objects in the scene, creates a digital image equivalent to same. The controller receives the digital image. In one embodiment, a portion of the camera image (e.g., a user selected portion of the image, or, a portion recognized by an algorithm present on the VAD or a remote platform) is rendered to a pixel equivalent tongue presentation image (e.g., a 20×20 or larger (e.g., more than 400) or smaller (e.g., less than 400) pixel equivalent tongue presentation image) by the controller. In one embodiment, for a wide field of view, an appropriately sized region of the camera image is spatially averaged to establish the corresponding pixel value in the tongue image. For a very narrow field of view, camera pixels are replicated. The rendered tongue presentation image is then presented (e.g., raster scanned) onto a matrix/array of electrodes (e.g., the 20×20 matrix or larger or smaller array) on the IOD 2. Spatial relationships present in the camera image are maintained through the use of a one-to-one mapping between the position of an electrode on the array and an area in the user selected field of view. The stimulation intensity at each electrode is proportional to the luminance of the corresponding region of the image captured by the camera 10. The invention is not limited by the frame rate of the system. In a preferred embodiment, the frame rate of the system is sufficiently fast that the user perceives the visual signals as a continuous stream.

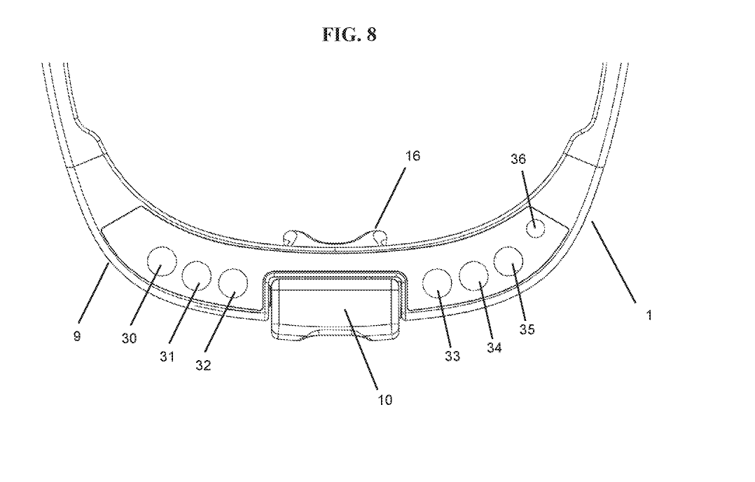

User controls 9 can be located on the headset 1 (See FIGS. 1 and 8). In one embodiment, because a user has limited or no useful natural sight, the placement and/or shape of the controls 9 provide the tactile information needed to differentiate among the controls 9. A number of different types of controls 9 can be integrated into a VAD 100 of the invention. For example, one or more controls 9 (e.g., control buttons) may provide the following core functions: Power on/off 36; System Status 33; Stimulation intensity (e.g., 0 to 100%=0 to 16 Volts); Camera Image zoom in/out (e.g., 3° to 48°); Stimulation inversion; Contrast—normal (grayscale) or high (black/white); Edge Enhancement; Volume—used to adjust audible volume (default, low, mute); WiFi Enable/disable; Test—test pattern presented to electrode array, allowing user to verify correct stimulation performance. In one embodiment, the camera housing 50 on the headset 1 can tilt (e.g., upwards or downwards (e.g., between 5-65 degrees (e.g., 30, 35, 40, 45, 50, 55, or more degrees))) to minimize user neck strain when looking down.

In one embodiment, feedback provided to a user (e.g., of VAD 100 status after pressing control button (See FIG. 8, 30, 31, 32, 33, 34, 35, 36), or, feedback from an algorithm located on a remote platform) can be non-visual. For example, feedback can be provided via tactile (e.g., via tongue stimulation) and/or audible subsystems within and/or attached to the controller. Similar to commercial devices such as cellular phones, a VAD 100 of the invention can provide synthesized voices and tones to inform the user of status/changes and/or visual information.

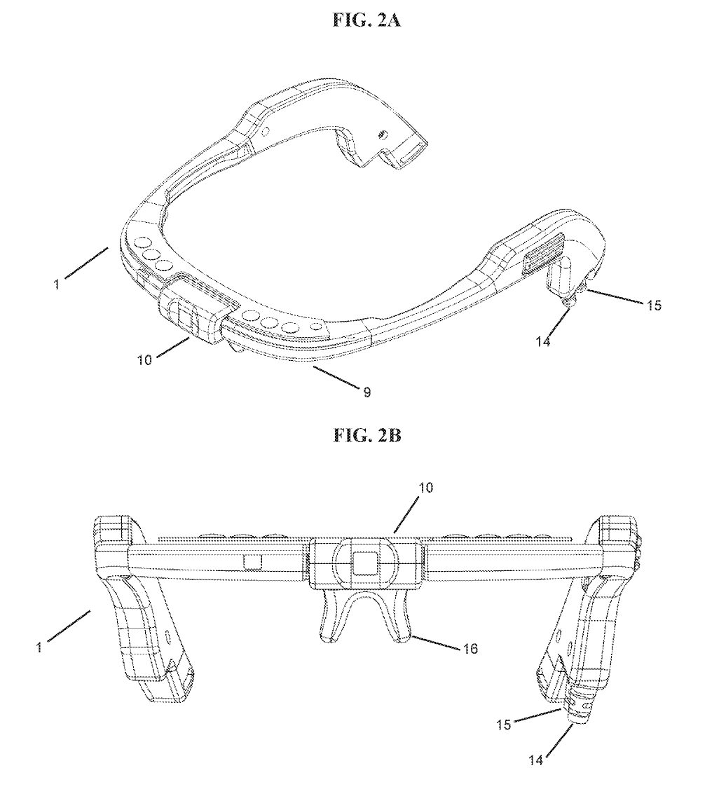

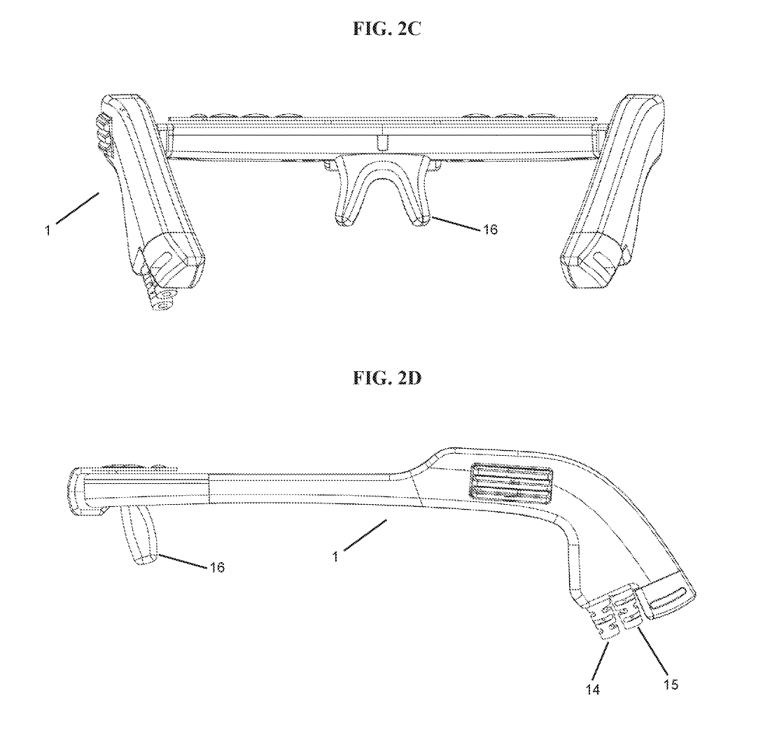

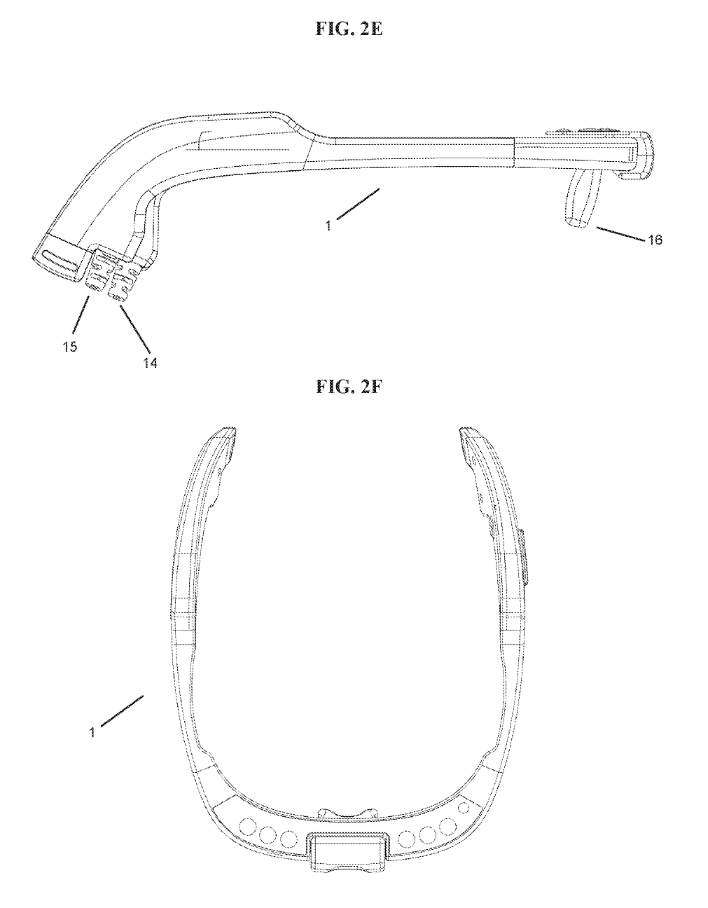

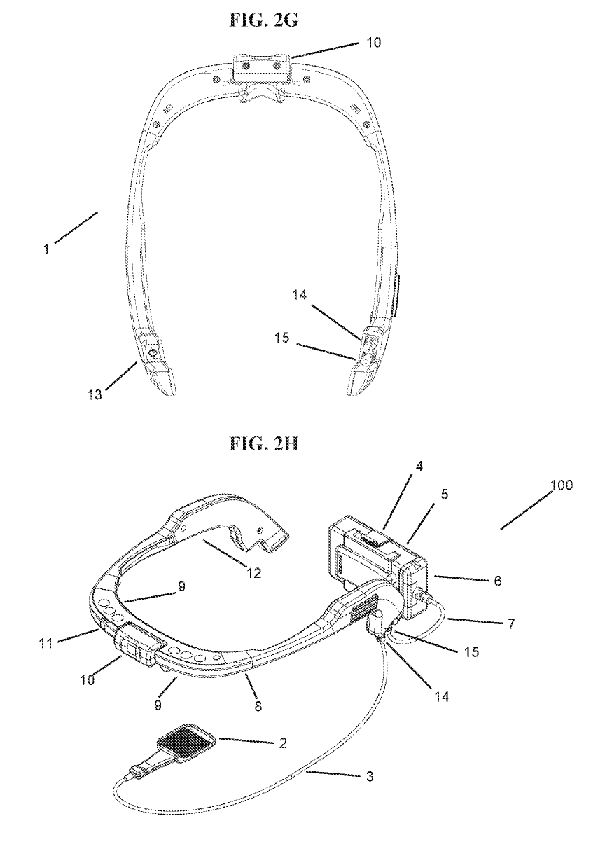

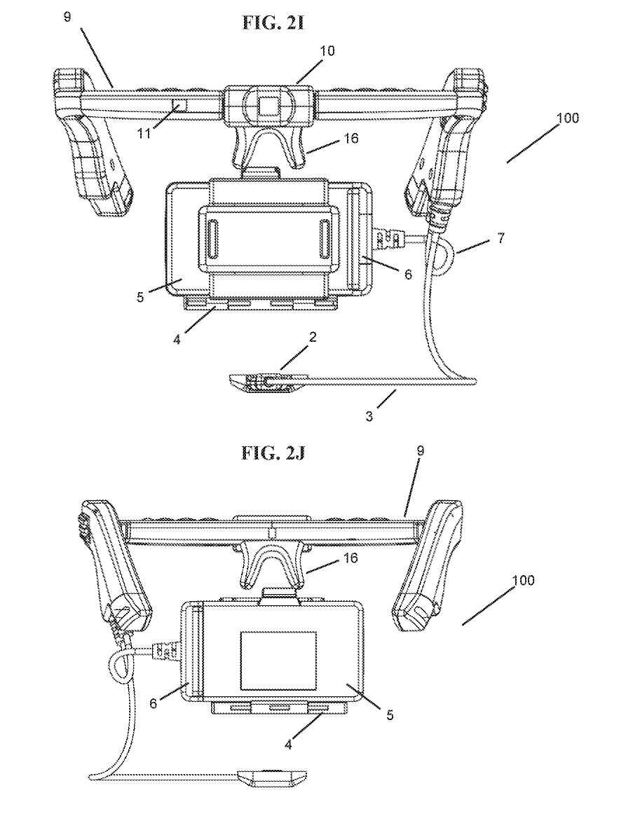

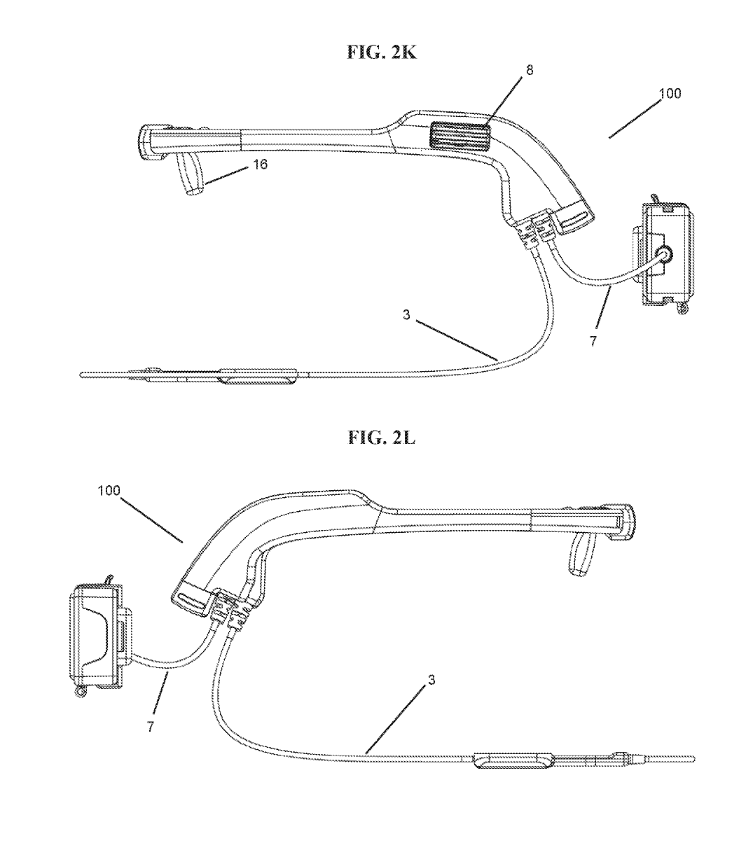

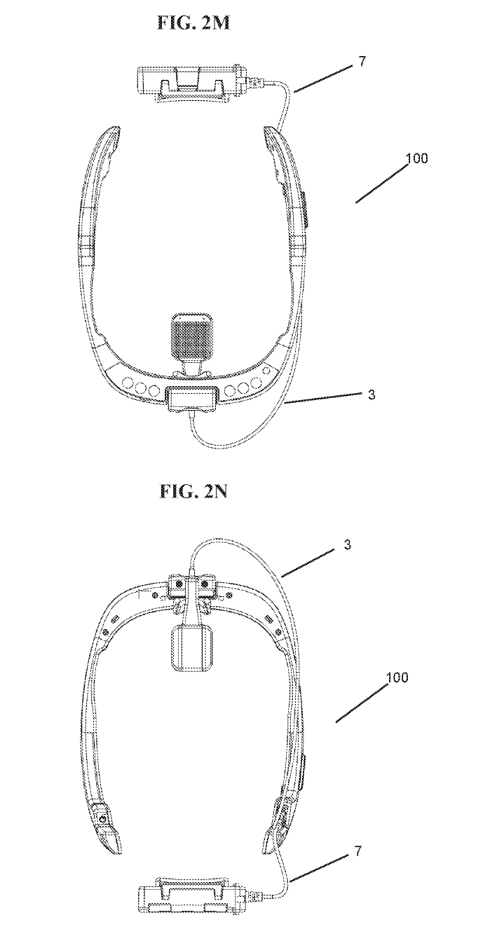

Additional exemplary drawings of a VAD 100 of the invention are shown in FIGS. 2A-2N. FIG. 2A is a three-quarter perspective view of the VAD 100. FIG. 2B is a front elevational view of the VAD 100. FIG. 2C is a rear elevational view of the VAD 100. FIG. 2D is a right side elevational view of the VAD 100. FIG. 2E is a left side elevational view of the VAD 100. FIG. 2F is a top plan view of the VAD 100. FIG. 2G is a bottom plan view of the VAD 100. FIGS. 2H-2N depict a device incorporating the headset 1. FIG. 2H is a three-quarter perspective view of the device. FIG. 2I is a front elevational view of the device. FIG. 2J is a rear elevational view of the device. FIG. 2K is a right side elevational view of the device. FIG. 2L is a left side elevational view of the device. FIG. 2M is a top plan view of the device and FIG. 2N is a bottom plan view of the device.

An exemplary headset 1 of a VAD 100 of the invention is shown in FIG. 1. In one embodiment, the headset contains printed circuit assemblies (PCAs) and flex cables for components of the headset 1, including, but not limited to, membrane switch assembly; camera PCA; sensor PCA; ambient light PCA; SOM Carrier PCA; SOM2Sensor Cable PCA (e.g., Rigid-Flex Cable with Connectors at each end); Antenna PCA; and/or Audio PCA. The headset 1 may also include temple Arms (e.g., Left and Right), audio flex cables, plastic housing components, strap holders, and/or arm inserts.

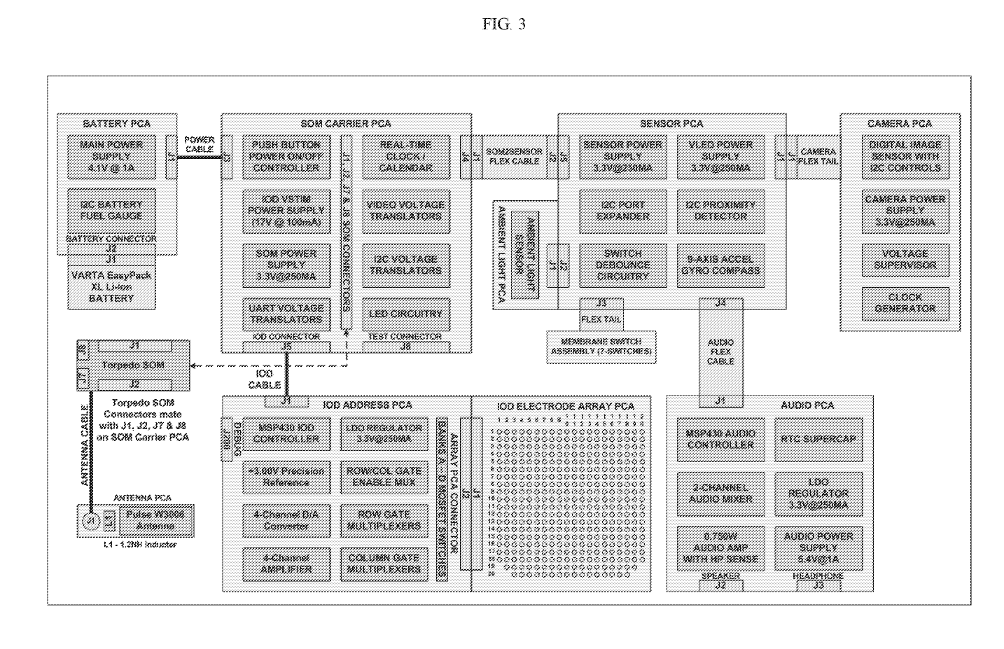

One exemplary VAD 100 of the invention can include a number of interconnected subsystems which, in conjunction with software components, work to provide core functionality of the device (See, e.g., FIGS. 1-2 and 4-8). These subsystems can include Printed Circuit Assemblies (PCAs) interconnected by custom cables (e.g., as shown in FIG. 3).

Processing Subsystem. A Processing Subsystem is located in the headset housing. In one embodiment, the invention provides a housing that is designed specifically to accept the circuit boards and cabling as described and shown in FIG. 3.

Torpedo SOM. An exemplary Torpedo SOM is a LogicPD DM3730 TORPEDO™+ Wireless System On Module. The SOM can be installed on the SOM Carrier PCA. An antenna (Antenna PCA) can be connected to the WiFi module integrated with the SOM. The SOM can be powered via the Main Power Supply on the Battery PCA. The SOM, via the SOM Carrier PCA, monitors and/or controls the other subsystems in the VAD 100. The Torpedo SOM may be a computer executing the Linux operating system and custom VAD 100 application software. For example SOM 8 functionality can include, but is not limited to: Configuring device settings at start up; Modifying device settings during operation; Managing camera image acquisition and processing; Monitoring and responding to user controls 9, including but not limited to On/off power, Status requests and mode control, Battery state, Volume, WiFi, Test Image related status/mode control, Intensity, Zoom, Contrast, Inversion, and/or Edge Enhancement; Generating audio output (e.g., to provide feedback to the user); Creating and sending stimulation patterns to the Intra-Oral Device (IOD) 2; Monitoring the ambient light sensor 11 (e.g., to track lighting conditions); Monitoring the proximity sensor 24 to determine when the headset is being worn; Monitoring the inertial measurement unit sensor (accelerometer, gyroscope, compass) to track motion and orientation of the headset 1; Monitoring the battery state (e.g., via a battery fuel gauge); Setting and monitoring the real-time clock/calendar component; Allowing remote connections (e.g., via wireless connection (e.g., via the WiFi (802.11a/b/g/n) interface and Antenna); and/or streaming images, commands, and/or status data to/from remote platforms.

SOM Carrier. The SOM Carrier PCA provides the electro-mechanical interface between the SOM 8 and the other headset hardware components. The Torpedo SOM 8 is plugged into receiving connectors on the SOM Carrier PCA. In addition to the SOM connectors, the SOM Carrier PCA can include: Push Button Power On/Off Controller (e.g., In the OFF state, a momentary press of the Power Button (See, e.g., User Control Buttons 9 in FIG. 1) will enable the Main Power Supply on the Battery PCA, and the device will enter the ON state; When in the ON state, a press-hold (e.g., 1-3 seconds) will disable the Main Power Supply and the device will enter the OFF state); Voltage Translators (e.g., devices used to translate logic voltage levels between devices that operate at different voltages); Real-Time Clock/Calendar (e.g., a device that retains the current time-of-day and date, once set by the SOM 8 (e.g., this device can communicates with the SOM 8 via the I2C bus)); IOD VSTIM Power Supply (e.g., Used to provide power (e.g., 17V at up to 100 mA) to the stimulating electrodes (e.g., the supply can be turned ON/OFF by the Torpedo SOM 8); SOM Power Supply (e.g., used to supply clean 3.3V power to the Torpedo SOM 8 (e.g., this supply can be enabled when the Main Power Supply starts)); LED Circuitry (e.g., the Torpedo SOM 8 illuminates a green LED when the software boot process starts, and an amber LED when the IOD VSTIM power supply is enabled). In one embodiment, the SOM Carrier connects to the Battery PCA via the 6-conductor Power Cable 7 with internal shield. The shield is connected at the SOM Carrier. In one embodiment, the SOM Carrier connects to the Sensor PCA 23 through a custom flex cable 18 (e.g., a 30-conductor flex cable). In one embodiment, the SOM Carrier connects to the IOD Addressing PCA via a IOD Cable 3 with internal shield (e.g., a 6-conductor cable with shield). The shield can be connected at the IOD 2 end.

Antenna PCA. The Antenna PCA comprises the antenna subsystem and interconnects and can be used to broadcast radio frequency (RF) signals. It can be connected directly to the SOM 8 via a custom-length cable and is designed in accordance to rules specified by LogicPD to ensure that the SOM's FCC and IC ID's be used without modification. It can be placed within the VAD 100 housing in a location ensuring compliance with Specific Absorption Rate (SAR) limits for Body Worn Devices.

Power. The Power Subsystem can also be located in the Battery Housing 4 which is connected to the SOM Carrier PCA by a Power Cable 7 (e.g., a 6-conductor cable). The Battery Housing 4 is designed to accommodate the Battery 5, Battery/Power PCA 6, and Power Cable 7.

Battery. A VAD 100 of the invention can use any type of rechargeable battery 5. In one embodiment, the VAD 100 uses a VARTAEASYPAK XL battery or any other type of battery that can provide 2200 mAh at 3.7V (e.g., that conforms to IEC 63133).

Battery PCA. The Battery PCA 6 can include: a Battery Connector (e.g., that provides the ‘+’ and ‘-’ connection terminals for the battery 5); a Battery Fuel Gauge (e.g., that monitors the battery charge state (e.g., can be connected directly to the battery for monitoring purposes, and, connected to the SOM 8 via I2C bus (over Power Cable 7) (e.g., allowing the SOM 8 to query the Fuel Gauge for the current battery state))); and/or Main Power Supply (e.g., that converts battery power to a constant 4.1V supply (max 1 A)). In a preferred embodiment, the Battery PCA 6 is designed to fit within the Battery Housing 4.

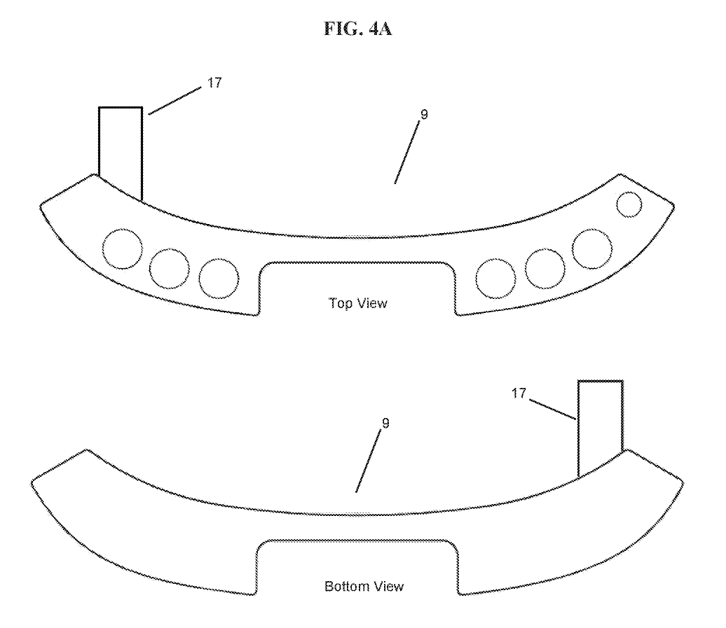

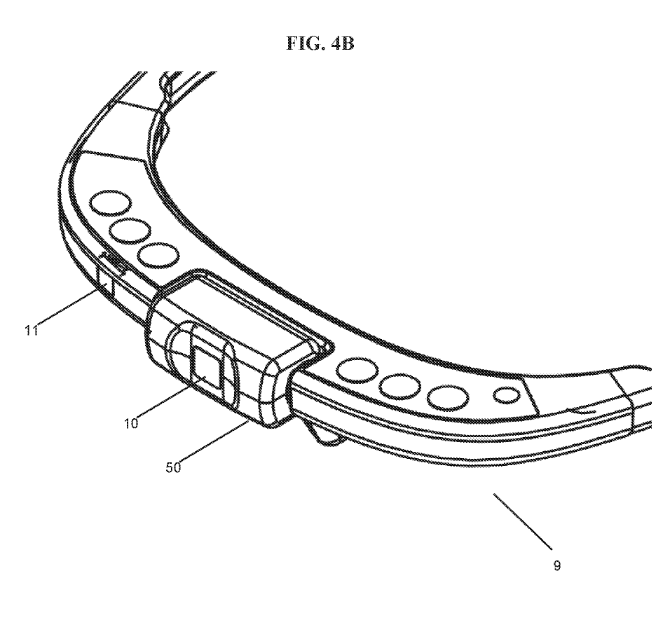

User Controls—Hardware. User Controls 9, in one embodiment, are located at the front of the headset 1 frame on the top piece (See, e.g., FIGS. 1 and 8). In one embodiment, the control buttons 30, 31, 32, 33, 34, 35, 36, are implemented as a Membrane Switch Assembly 9 (See FIGS. 4A and 4B) providing 7 Single-Pull/Single-Throw, Momentary, Normally Open switches that terminate in a flex-pigtail 17. The flex tail 17 is connected to the Sensor PCA 23. Each Control Button is implemented as a metal dome switch with actuation force (e.g., an 8 mm diameter metal dome switch with 180 g actuation force).

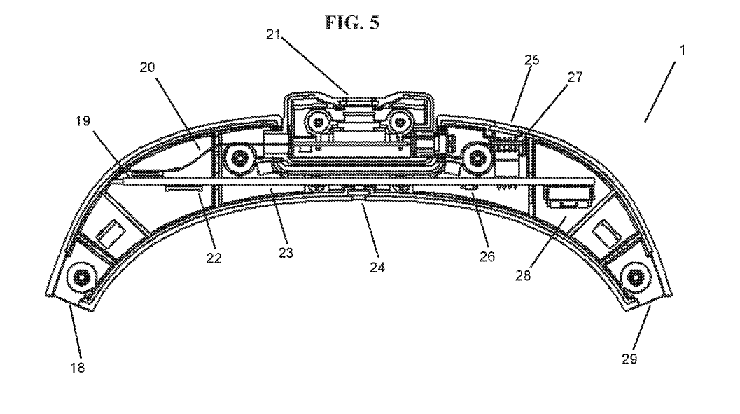

Sensor Subsystem. In one embodiment, a Sensor Subsystem (e.g., that integrate a number of VAD100 Sensors), is located in the front section of the headset 1 frame (See FIG. 5).

Sensor PCA. The Sensor Subsystem PCA 23 (See FIG. 5) acts as an integration hub for the sensors in the headset 1, the user controls 9, and the audio subsystem 12. The Sensor PCA 23 is custom designed to fit within the VAD 100 Headset 1 Front Housing and provides: Power and signaling connectivity among sensor components and the SOM Carrier 8 and Battery PCAs 6; Debounce circuitry for the controls buttons on the membrane switchpad 9; Separate power supplies (e.g., 3.3V power supply) for the Ambient Light 27/Proximity Detector 24 and the Proximity Sensor LED; and/or connection points for the membrane switch flex tail 17, audio flex cable 29, camera flex tail 20, and/or SOM2Sensor flex cable 18. The Sensor Subsystem PCA 23 may include a camera connector 19, a SOM carrier connector 22, an audio connector 26, and/or a membrane switch connector 28.

Camera PCA. The Camera PCA is mounted within the Camera Housing 50 (See FIG. 5). This PCA is a rigid-flex design that includes the digital image sensor and lens 21. A flexible circuit extension 20 of the PCA allows the Camera PCA (inside its housing) to tilt to 45 deg, up or down.

Image Sensor. In one embodiment, a camera image sensor of a VAD 100 of the invention has the following characteristics:

TABLE 1
Exemplary characteristics of a camera
image sensor of a VAD of the invention.

| Optical Fmt | ⅓ inch |
|---|---|
| Image Size, Horz (mm) | 4.51 |
| Image Size, Vert (mm) | 2.88 |
| Image Size, Diag (mm) | 5.35 |
| Active Pixels | 752 × 480 |
| Pixel Size (μm) | 6 |
| Circle of Confusion | 0.012 |
| Shutter | Global |
| Responsivity (V/lux-sec) | 4.8 |
| Dynamic Range (dB) | 80 |
| SNR (dB) | 45 |

Any sensor possessing these characteristics can be used including, but not limited to, an APTINA MT9V024 Digital Image Sensor.

Lens. In one embodiment, a lens 21 used in conjunction with the Image Sensor has the following characteristics: an Effective Focal Length (EFL): 3.3 (e.g., an EFL to provide at least camera 45 deg field of view); Lens height: 4.5 mm+/−10% (e.g., that is capable of fitting in the VAD 100 camera housing 50/lens holder); an image Circle: >4.0 mm; and/or an IR Filter: 645 nm.

The electrodes of an IOD 2 array of a VAD 100 of the invention are arranged in a grid (e.g., a 20×20 spatially square grid). To match the aspect ratio of the IOD 2 array, the VAD 100 crops the image sensor data so that the spatial arrangement of pixels used for image processing is also square, with the center of the pixel group centered on the images sensor. The ‘image circle’ of the lens 21 must at least cover the selected set of pixels. The invention is not limited to any particular lens 21. In one embodiment, a 14033MPF lens with the following specifications is use: Size: ¼″, EFL 3.3 mm, F2.8, M7*0.35 mount lens with IR filter.

Ambient Light Sensor PCA. The Ambient Light Sensor PCA 27 includes a Light-to-Digital Ambient Light Photo Sensor that converts light intensity to digital signal output capable of direct I2C interface. This digital output is monitored by the Torpedo SOM 8 where illuminance (ambient light level) in lux is derived using an empirical formula to approximate the human-eye response. The Ambient Light Sensor is connected to the Torpedo SOM 8 via the I2C communication bus. The invention is not limited to any particular light sensor 25. In one embodiment, an APDS-9301 Miniature Ambient Light Photo Sensor with Digital (I2C) Output is used.

Proximity Sensor. The Sensor PCA's Proximity Detector 24 is located on the back side of the Sensor PCB, in line with an opening in the headset 1 and a corresponding protective lens, allowing it to detect when the user is wearing the headset 1. By monitoring this signal, the Torpedo SOM 8 may enter low-power or power-down mode once the headset 1 is removed, thus significantly extending battery life (e.g., without need for user action to power-down or power-up the apparatus). The proximity sensor 24 can detect objects up to 100 mm distant. Proximity detection is accomplished by enabling the IR LED transmitter, then measuring the amount of energy reflected off the nearest object and received by the IR Detector. The Proximity Sensor 24 is connected to the Torpedo SOM 8 via the I2C communication bus. The invention is not limited to any particular proximity sensor 24. In one embodiment, an Avago APDS-9130 is used.

Motion Tracking Unit. The Sensor PCA 23 includes a Motion Tracking Unit (MTU) which can include a 3-Axis Accelerometer, 3-Axis Gyroscope, 3-Axis Magnetometer, and temperature sensor. By monitoring the data outputs of the MTU, the Torpedo SOM 8 can determine the orientation of the headset 1, whether the headset 1 is in motion, and the direction of motion. The MTU is connected to the Torpedo SOM 8 via the I2C communication bus. In one embodiment, the WiFi module is capable of IEEE 802.11abgn, GPS (Global Positioning System), and Bluetooth wireless data communication. In one embodiment, IEEE 802.11abgn is the hardware mechanism that is used to wirelessly transmit data bi-directionally, via a structured data streaming network protocol, in real-time or training mode, to remote platform. GPS is a hardware mechanism that can be used to provide wireless location data for the end user. Bluetooth is a hardware mechanism that can be used to provide wireless short-range data communication (e.g., with other remote platforms).

The invention is not limited to any particular motion tracking unit or components thereof. In one embodiment, the InvenSense MPU-9250 Multi-Chip Module is used. Software can be configured and used to transmit images and/or data from the controller to a remote platform that allows software executing on those platforms to store images and/or data in a remote database. The images and/or data can be recalled at a later time (e.g., for use by the same or different user). For example, MTU data which indicates the orientation of the headset with respect to the horizon can be captured concurrently with image data and stored with the image data so that the same user at a different time can access the data in order to recreate the headset orientation when viewing the same scene. This could be useful to help the user (or another user) in quickly viewing the same location in a scene (e.g., a traffic light, or, an indoor landmark such as a bathroom or exit). Furthermore, GPS data (e.g., location coordinates and/or time) indicating the location of the headset (and user) can be captured concurrently with the images and stored in a remote database. At a subsequent time, the same (or different) user can query the remote database to recall the GPS-linked databased locale, using the data to travel to the locale to view the same scene (e.g., one or more times (e.g., repeatedly)).

Tongue Stimulation. The IOD 2 rests on the tongue of the user and stimulation occurs through electrodes 37 on the bottom surface of the IOD 2. Current flow between an electrode and the tongue acts to stimulate nerves in the tongue. Users describe the stimulation as a slight tingling, buzzing, or bubble-like sensation. In one embodiment, no more than four electrodes are simultaneously active. In another embodiment, active electrodes are separated by at least 4 inactive electrodes. In a further embodiment, all 396 inactive electrodes serve as a common return for the 4 active electrodes.

The Intra-Oral Device (IOD) 2 assembly comprises the IOD Electrode Array PCA, the IOD Address PCA, and the IOD Cable 3 used to connect the IOD assembly 2 to the headset 1. In one embodiment, the IOD Electrode Array 37 is a custom PCA that contains one switched circuit per electrode (e.g., 394 switched circuits). The electrodes are arranged in a grid (e.g., 20 row by 20 column square grid) spaced evenly (e.g., at 1.32 mm (0.052 in.) center-to-center). The Electrode Array 37 is connected to the IOD Address PCA via a high density connector. Electrode row and column activation signals are received from the addressing board via the high density connector. These activation signals enable and disable the switched circuits on the array. When a switch is enabled, the electrode array 37 gates an analog voltage from the addressing board to the activated electrode.

The IOD Address PCA is a custom printed circuit assembly. The Address PCA accepts stimulation patterns from the Torpedo SOM 8. It uses this data to drive the electrode row and column activation signals. The row/column activation signals are implemented such that the electrode array 37 is activated in a raster scan fashion. The magnitudes of the voltage signals are proportional to the luminance of the pixels in the IOD image (e.g., the 20×20 rendering of the camera image). The IOD image pixels correspond to the electrodes that are activated by the row and column signals. During the manufacturing process the electrode array 37, addressing board, and cable 3 are joined and then encapsulated in a biocompatible epoxy. The epoxy protects the electronics and provides mechanical rigidity for the completed assembly. After encapsulation, the epoxy is polished to fully expose the electrodes and remove any rough edges. The silicone sleeve placed over the flexible cable is butted up against the edge of the epoxy and glued in place with a silicone glue to complete the subassembly.

Audio PCA. The Audio PCA includes a speaker, an audio controller, power supply, and amplifier. In addition, a supercapacitor, used to provide long-term power to the Real-Time Clock, can be located on this PCA. In one embodiment, the invention utilizes a speaker with the follow characteristics to provide audio feedback to a user, driven by either the Torpedo SOM or MSP340 Audio Controller: Frequency Range: 300 Hz˜17 kHz; Impedance: 8 Ohm; Sound Pressure Level: 73.5 dB; Power—Rated: 600 mW; Power—Max: 1.2 W.

In one embodiment, the MSP340 Audio Controller executes embedded firmware and has a single digital input from the Torpedo SOM. When the digital input is OFF, the MSP340 Audio Controller drives the speaker 12 with an audio sequence. When the digital input is ON, the MSP340 Audio Controller releases control of the speaker 12 to the Torpedo SOM, which can then drive the speaker 12 with its own audio sequences. In addition, the Audio PCA includes a 2-Channel Audio Mixer such that when a headphone jack is inserted in to the headphone receptacle, all audio output is routed to the headphone instead of the speaker 12.

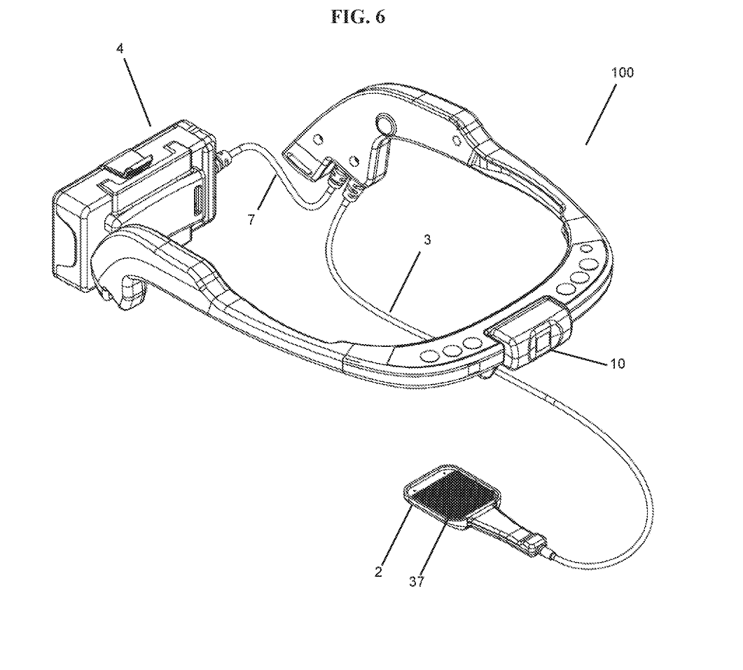

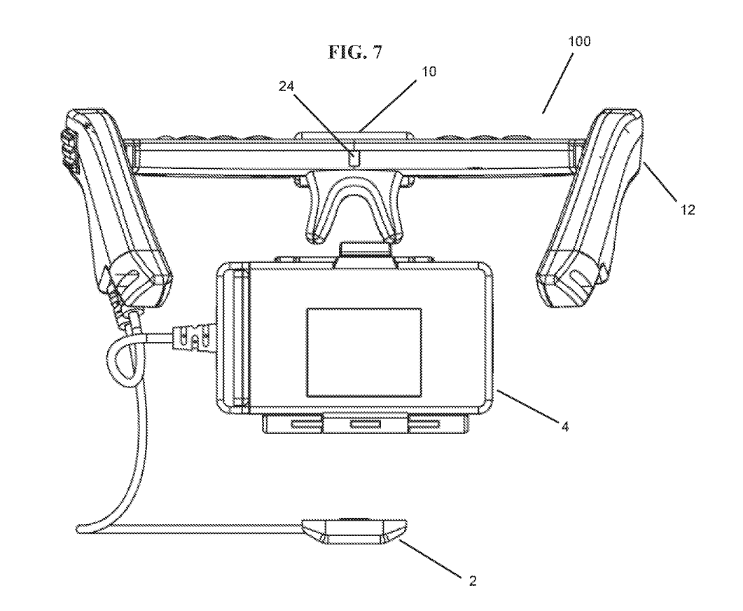

V200 Battery Housing. In one embodiment, a Battery Housing 4 is a source of power for a VAD 100 of the invention and contains the following: V200-3V7P-Power PCA (Power PCA); VARTA EasyPack XL 3.7V, 2260 maH Li-Ion Battery Pack. In one embodiment, the VAD 100 Battery Housing 4 connects to the VAD 100 Headset 1 with a Power Cable 7, as shown in FIG. 6.

An exemplary VAD 100 of the invention is shown in FIG. 7. Several of the visible components are shown in FIG. 7 including:

| | |
|---|---|
| Camera 10 | Used to capture the scene in front of the wearer |
| Speaker 12 | Provides audio feedback |
| Battery Case 4 | Contains the rechargeable battery. |
| | Mounted on the rear of the headset 1 |
| | with an adjustable strap |
| | Detects when headset 1 is being worn. |
| Proximity Sensor 24 | The system will shut down if after |
| | several minutes if the headset 1 is |
| | removed |
| IOD 2 | Contains the electrodes which present |
| | the stimulation patterns to your tongue. |

Exemplary User Controls that can be integrated into a VAD 100 of the invention are shown in FIG. 8. Control buttons can be configured, as shown in FIG. 8, to control

Power (36) (e.g., the device on/off button (e.g., to turn the device on or off, press the button));

System (33) (e.g. this button scrolls through the System features (e.g., the Up (34) and Down (35) buttons next to System selects the specific action for that feature. In one embodiment, System features can be configured as follows:

Status: Up/Down will cycle through following status reports, announcing the information at each stop
the battery charge level,
Lighting condition detected by the device
the version of the device;

Volume: Up/Down will cycle through the following volume levels, changing the volume to the currently selected feature
mute,
low,
high;

WiFi: Up or Down buttons enable or disable the WiFi (e.g., Disabling the WiFi will help conserve battery life); and/or

Test: Up and Down buttons to choose test patterns (e.g., Used for troubleshooting device operation).

Imaging (32) (e.g., the Imaging button 32 scrolls through the Image features (e.g., use the Up (31) and Down (30) buttons to choose the level desired for each feature. Exemplary Image features include, but are not limited to:

Intensity: Stimulation intensity control (e.g., Use the Up 31 and Down 30 buttons to increase or decrease (respectively) the intensity of the stimulation on the tongue (e.g., device will beep at the limits of stimulation (e.g., highest=100, lowest=0). At power up, stimulation intensity always resets to zero and must be increased to comfort level).

Zoom: Camera field of view (FOV) control (e.g., Use the Up and Down buttons to zoom in (smaller FOV) or out (larger FOV). Press the Up button to increase the camera zoom level (reducing the camera's effective field of view). Press the Down button to decrease the camera zoom (increasing the camera's field of view). The device will beep at the limits of zoom (e.g., widest=48 degrees, narrowest=3 degrees).

Invert: (e.g., invert the stimulation intensity values, where the strongest becomes the weakest and vice-versa (e.g., Use the Up and Down buttons to toggle between whether bright objects or dark objects in the field of view stimulate the tongue array)).

Contrast: Image contrast control (e.g., the Up and Down buttons toggle between normal contrast (default) and high contrast mode. High Contrast will enhance the difference between light and dark regions in the camera image.

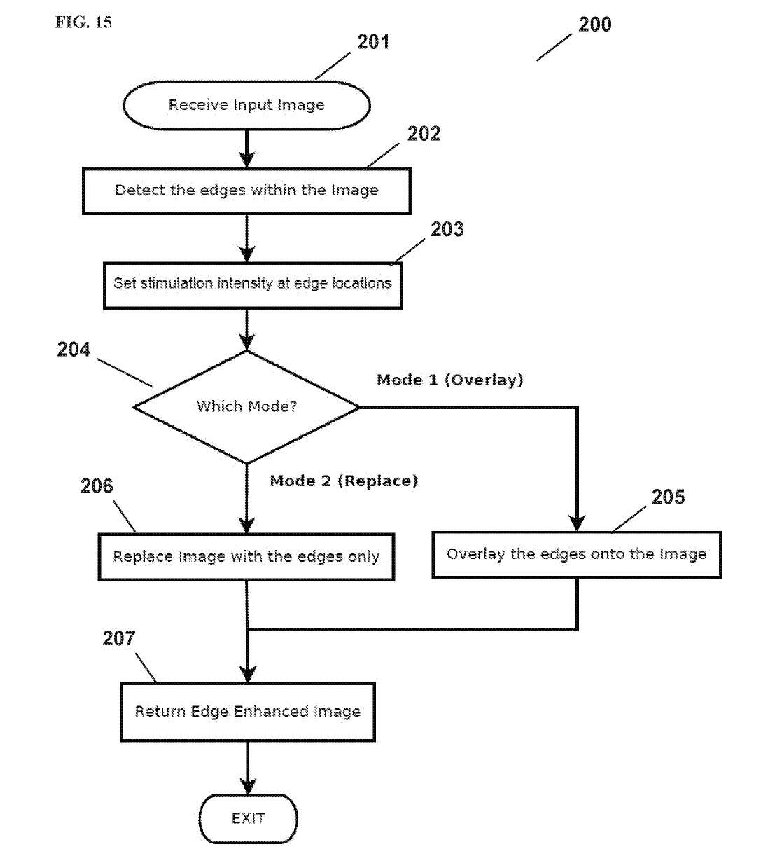

Edge Enhance: Enable/disable edge enhancement (e.g., Use the Up and Down buttons to enable or disable this function (e.g., in this mode, edges in the camera image are enhanced to make them easier to distinguish)). An exemplary process flow 200 relating to edge enhancement of objects within the visual field captured by a camera component of a VAD according to one embodiment of the invention in shown in FIG. 15. The edge enhancement feature of the VAD can be provided in a plurality of modes. For example, a first mode can provide the original image with detected edges highlighted and overlayed. In this mode, the user is presented a normal scene with higher stimulation at major object edges. In a second mode, provides only the detected and highlighted edges are presented to a user. In this mode, the user is presented a scene that only provides stimulation at major object edges. This second mode of edge enhancement provides a view of the scene that has reduced image noise and improved stimulation patterns.

For example, referring to FIG. 15, there is depicted an exemplary flow chart 200 for an Edge Enhancement Algorithm wherein the VAD receives image data according to an embodiment of the invention. As shown the process begins in step 201 with the VAD receiving image information (e.g., image data captured by a camera, or, from an image data stored on a remote platform) wherein the process proceeds to step 202 wherein edges of the object are detected within the image data wherein the process proceeds to step 203 wherein stimulation intensity values are assigned to edge locations in the image thereby defining the edges wherein the process proceeds to step 204 wherein if using the Overlay Mode 205 the edges are overlayed (added to) the received image thereby creating the Edge Enhanced Image, wherein if using the Replace Mode 206 the edges replace the received image thereby creating the Edge Enhanced Image, wherein the process proceeds to step 207 wherein the Edge Enhanced Image is returned (e.g., the image is made available as a stimulation pattern (e.g., presentable to the tongue via an IOD array)). In one embodiment, a VAD captures luminance data from digital images and translates that data to stimulation patterns presented to the tongue (e.g., via an array of electrodes in which each electrode has an applied voltage directly related to the magnitude of the luminance data at a corresponding image location). Thus, in one embodiment, wherein each electrode has an applied voltage directly related to the magnitude of the luminance data at a corresponding image location, equal weighting is given to objects near and far (e.g., so that when the 3-dimensional world (e.g., visual field of view) is mapped to a 2-dimensional stimulation array (e.g., IOD), a blind user experiences stimulation cluttered patterns. Experiments conducted during development of embodiments of the invention discovered that presentation of cluttered stimulation pattern presented a challenge to blind users when the user tried to interpret what the patterns mean. In order to address this challenge, in one embodiment, an edge detection algorithm 200 was utilized (e.g., to present only the detected edges in the stimulation pattern (e.g., thereby reducing the clutter experienced by the blind user (e.g., thereby increasing usefulness of the device))). In another embodiment, native visual information (e.g., images) is presented with enhanced edges (e.g., the edges of an object within the field of view is enhanced using an edge enhancement algorithm) by modifying the stimulation pattern (e.g., thereby providing context of the object to the user).

Additional components of a VAD 100 of the invention are also shown in FIG. 8. For example, a Camera (10) of the headset 1, as described herein, can adjusted to point straight out from the headset 1 or tilted down (to about 45 degrees) to reduce neck fatigue.

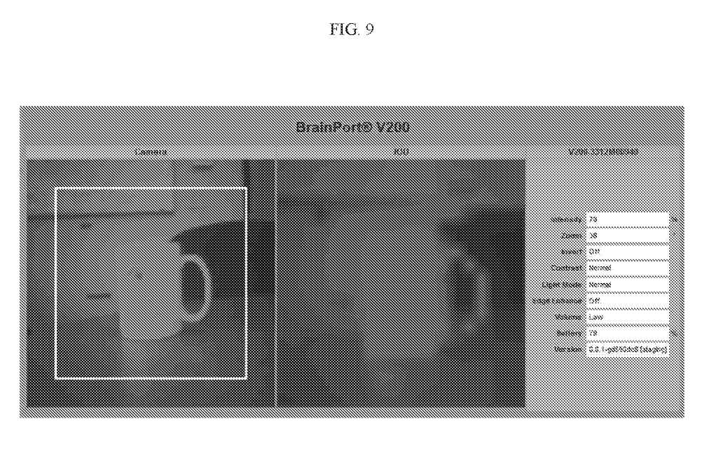

In one embodiment, a VAD 100 of the invention comprises a companion viewer. For example, a trainer or a sighted companion can use a web browser to view VAD 100 camera images and basic status information. Using a Mobile device with WiFi capability (e.g., a laptop, tablet, or smartphone), a sighted companion can establish a WiFi connection with the VAD 100 and display a webpage with the image and status information (See, e.g., FIG. 9).

Remote Platform Access. As described herein, in a preferred embodiment, the invention provided a VAD 100 that comprises not only a controller located in the headset, but also the components (e.g., wireless (e.g., WIFI) connections and antenna) that enable connection to a remote platform. Thus, in one embodiment, a remote platform connects with a VAD 100 of the invention via a WiFi (or other wireless connection scheme). Using a communication protocol, applications on the remote platform can exchange data with the VAD 100. Exchanged data may include, but is not limited to, image streams, status information, and/or command/control sequences. In addition, the data exchange can be bi-directional. For example, in one embodiment, the VAD 100 can send visual information (e.g., recorded by the camera (e.g., image stream)) to the remote platform (e.g., whereby the remote platform processes the image stream (e.g., detects, identifies and/or generates feedback regarding the image stream) and transmits information (e.g., visual information (e.g., processed image stream)) to the VAD 100 (e.g., that is used to augment or replace information presented to the user (e.g., via the IOD 2 and/or audible signals)). In one embodiment, the remote platform has connections to a plurality of VADs. In another embodiment, a VAD 100 of the invention has connections with more than one remote platform (e.g., two, three, four, five, or more remote platforms).

The invention provides, in another embodiment, algorithms and/or software to be used in conjunction with methods and/or apparatus of the invention (e.g., software is executed on the Torpedo SOM 8 and/or a connected Remote Platform in conjunction with any method or apparatus described herein). As described herein, the invention is not limited to any particular remote platform. Indeed, a variety of remote platforms may be used in the methods and apparatus of the invention including, but not limited to, smart phones (e.g., iOS and Android-based tablets), tablets (e.g., iOS and Android-based tablets), desktop PCs (e.g., running any operating system that can connect (e.g., wirelessly or hardwired) to a headset component of a VAD of the invention). Furthermore, any software algorithm could be encoded into hardware and/or software to improve performance, reduce cost, etc.

In one embodiment, structured network data formats used (e.g., JavaScript Object Notation (JSON), Extensible Markup Language (XML), Comma Separated Variable (CSV), etc.) to provide standards compliant information exchange with remote platforms. The communication channels can be secured using accepted encryption mechanisms (e.g., Secure Socket Layer (SSL) and Transport Layer Security (TLS)). The combination of data structure and security can be used for visual information and control data transmission. In one embodiment, information that originates from a remote and/or external database must be formatted and secured to be accepted by the VAD. In a further embodiment, a remote platform must make a secure connection and negotiate a predefined protocol, on a specific channel, in order to exchange information with the VAD.

Landmark Detection & Identification. For the blind user, the ability to locate a landmark of interest (e.g., signs, crosswalks, buildings, geographical locations, etc.) significantly improves the quality of life of the user. As described in detail herein, a VAD 100 of the invention provides a blind user with the heretofore unavailable ability to detect, identify, highlight and/or move towards a landmark (e.g., while navigating around, over, and/or through obstacles or structures within the user's environment). These newly gained abilities are a significant improvement over those provided by other devices available in the art. For example, a VAD 100 of the invention allows a blind user to accurately locate a restroom or exit (e.g., via detection, identification, and/or guidance toward a restroom and/or exit sign) without requiring assistance of a sighted individual (e.g., who may not be available).

For example, in one embodiment, using a camera 10 component of the VAD 100 device, visual information (e.g., a digital image stream) of the environment is captured, relayed to the controller and/or remote platform, examined and/or processed (e.g., by software and/or hardware algorithm for a landmark of interest (e.g., for Exit sign, Women's Room sign, or Men's Room sign). If a landmark is in the camera 10 field of view, the VAD 100 alerts the user alerts (e.g., by alert means (e.g., haptic means, audible means, etc.) the user to the presence of the landmark. In another embodiment, the VAD 100 guides the user to the landmark by highlighting the landmark in visual information provided to the user via the IOD 2.

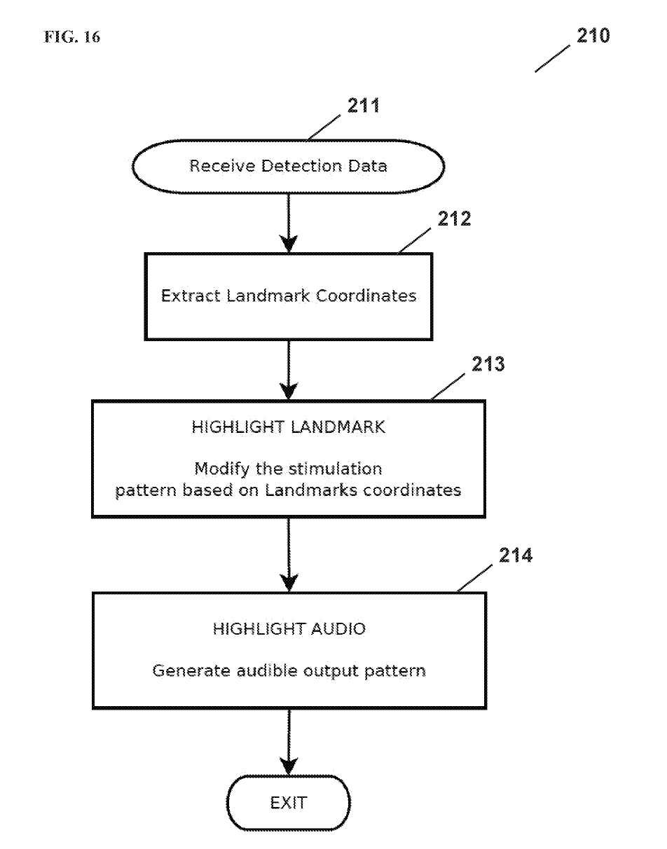

For example, referring to FIG. 16, there is depicted an exemplary flow chart 210 for a VAD receiving image data according to an embodiment of the invention. As shown the process begins in step 211 with the VAD receiving image information (e.g., image data captured by a camera, or, from an image data stored on a remote platform) wherein the process proceeds to step 212 wherein landmark coordinates which locate the landmark in the image are extracted wherein the process proceeds to step 213 wherein the landmark coordinates are used to highlight the landmark, wherein said highlight includes modifying the stimulation pattern based on the landmark coordinates, wherein said modified stimulation pattern may include, but is not limited to, enhancing the image edges in the vicinity of the landmark, artificially adding edges to the image in the shape of a rectangle (or other geometric shape) centered at the landmark, and/or changing the stimulation waveform in the vicinity of the landmark, and wherein the process proceeds to step 214 wherein an audio pattern is generated for output to alert the user that a landmark has been highlighted.

In one embodiment, a sign detection algorithm is based on a sliding window approach, in which a small window is translated (e.g., “slid”) over the entire image. For each type of target sign to be detected, the corresponding sliding window has a fixed aspect ratio, and multiple scales are used to capture the signs at different apparent sizes in the image. For example, for an Exit sign, these windows range in size from 18×12 to 216×144 pixels, whereas for a Restroom sign, the size ranges from 12×32 to 120×320 pixels. In one embodiment, each image patch is converted to a visual descriptor, which is fed into a classifier that determines whether an image patch is classified as containing a sign of interest or not. The search is conducted over multiple scales to accommodate a range of viewing distances (e.g., with adjacent scales separated by a factor of 1.5, although the factor could be higher or lower). In one embodiment, this results in roughly ˜105 candidate image patches for each image that is classified as “SIGN” (presence of sign) or “NO SIGN” (sign is not in field of view).

In one embodiment, the overall classifier for each patch is based on a cascade of filters in a boosting paradigm, with filters in each stage removing patches from subsequent consideration if they are classified as NO SIGN; at each successive layer fewer image patches need to be analyzed. In a further embodiment, at the end, a more discriminative (but computationally intensive) classifier is used to make a final SIGN/NO SIGN decision on the remaining candidate image patches, typically much fewer in number (e.g., a few tens of candidates per image).

In one embodiment, a Region of Interest (ROI) which encompasses the image area containing the detected landmark can be used to highlight the corresponding region on tongue display, thereby assisting the user in keeping the sign in the field of view (and navigating towards the landmark).

In one embodiment, a landmark detection algorithm is executed locally (e.g., on the VAD 100), or remotely (e.g., on a remote platform (e.g., on a smart phone, tablet, PC, or similar device (e.g., using WiFi or other wireless or wired connection)). In one embodiment, for remote execution, a data exchange protocol is used between the VAD 100 and the remote platform. In one embodiment, the remote platform sends audio/haptic feedback to the user.

The VAD captures image data via its digital camera. The image data is processed by the Detection Algorithm. The Detection Algorithm, among other operations, compares the image content against data stored in a Database. The results of the comparisons are returned to the VAD. In some cases, no object is detected in the image. In other cases, there is a detected object in which case the VAD will provide feedback to the user. In one embodiment, the database(s) and Detection Algorithm are co-located with the VAD. In another embodiment, the database(s) and Detection Algorithm are located separately (e.g., the detection algorithm is located on the VAD and the database is stored on a remote database, or, vice versa).

For example, referring to FIG. 14, there is depicted an exemplary flow chart 220 for a VAD according to an embodiment of the invention. As shown the process begins in step 221 with the VAD receiving image information (e.g., image data captured by a camera, or, from an image data stored on a remote platform) wherein the process proceeds to step 222 and image data is compared/checked against a database (DB) pattern wherein the process proceeds to step 223 wherein a determination is made as to whether there is a match between the input image data and the image pattern stored on remote platform database. If the determination is no, no detection information is returned to the VAD. If the determination is yes, the process proceeds to step 224 wherein detection information is returned to the VAD (e.g., to the user).

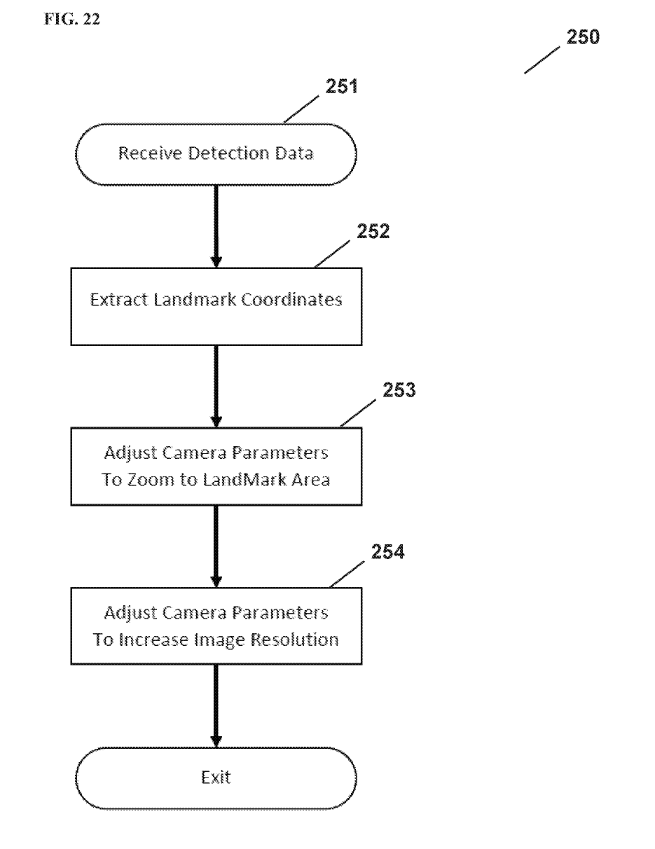

Referring to FIG. 18, in another embodiment, the VAD 230 captures image data via its digital camera. Using software executing locally on the VAD, the image data is processed by a Detection Algorithm 231 on the VAD. The Detection Algorithm 231, among other operations, compares the image content against data stored in a Database 232. The results of the comparisons are determined by the VAD 230. In some cases, no object is detected in the image. In other cases, there is a detected object. Exemplary Detection Algorithms are shown in FIG. 14 and FIG. 22.

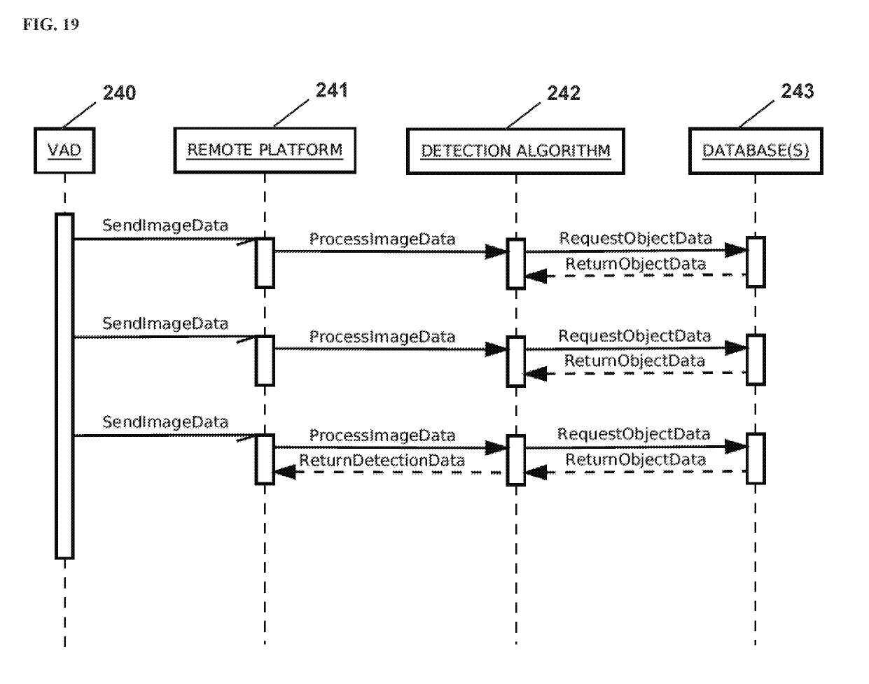

Referring to FIG. 19, in another embodiment, the VAD 240 captures image data via its digital camera. Using software (e.g., streaming software) to transmit images from the controller to a remote platform 241, the image data is processed by a Detection Algorithm 242 on the remote platform 241. The Detection Algorithm 242, among other operations, compares the image content against data stored in a Database 243. The results of the comparisons are returned to the VAD 240 via streaming software “from the remote platform 241. In some cases, no object is detected in the image. In other cases, there is a detected object. Non-limiting examples of Detection Algorithms are shown in FIG. 14 and FIG. 22.

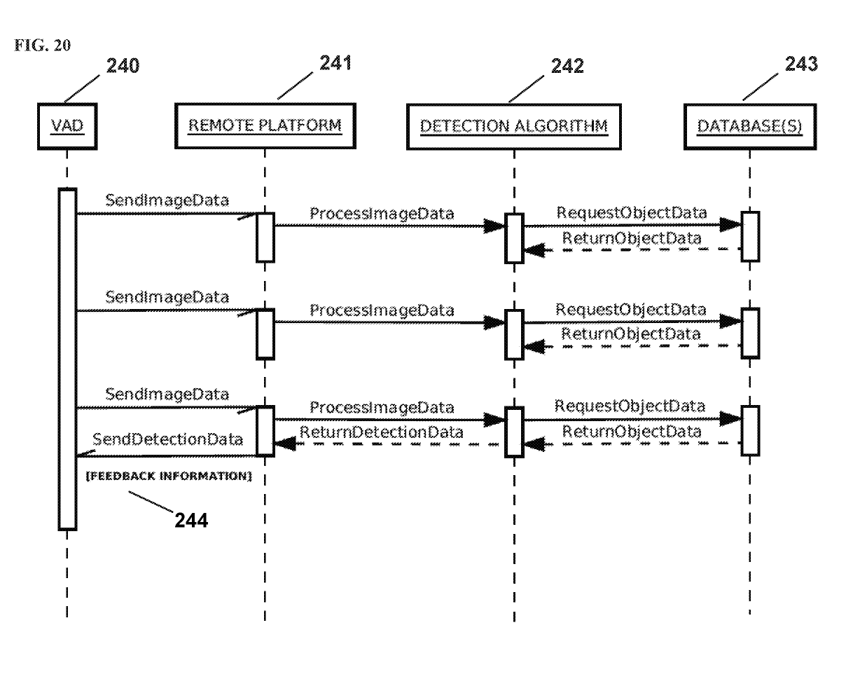

Referring to FIG. 20, in another embodiment, the VAD 240 captures image data via its digital camera. Using software (e.g., streaming software) to transmit images from the controller to a remote platform 241, the image data is processed by a Detection Algorithm 242 on the remote platform 241. The Detection Algorithm 242, among other operations, compares the image content against data stored in a Database 243. The results of the comparisons are returned to the VAD 240 via streaming software from the remote platform 241. In some cases, no object is detected in the image. In other cases, there is a detected object. When an identified object is detected, the VAD 240 will provide some feedback 244 to the user.

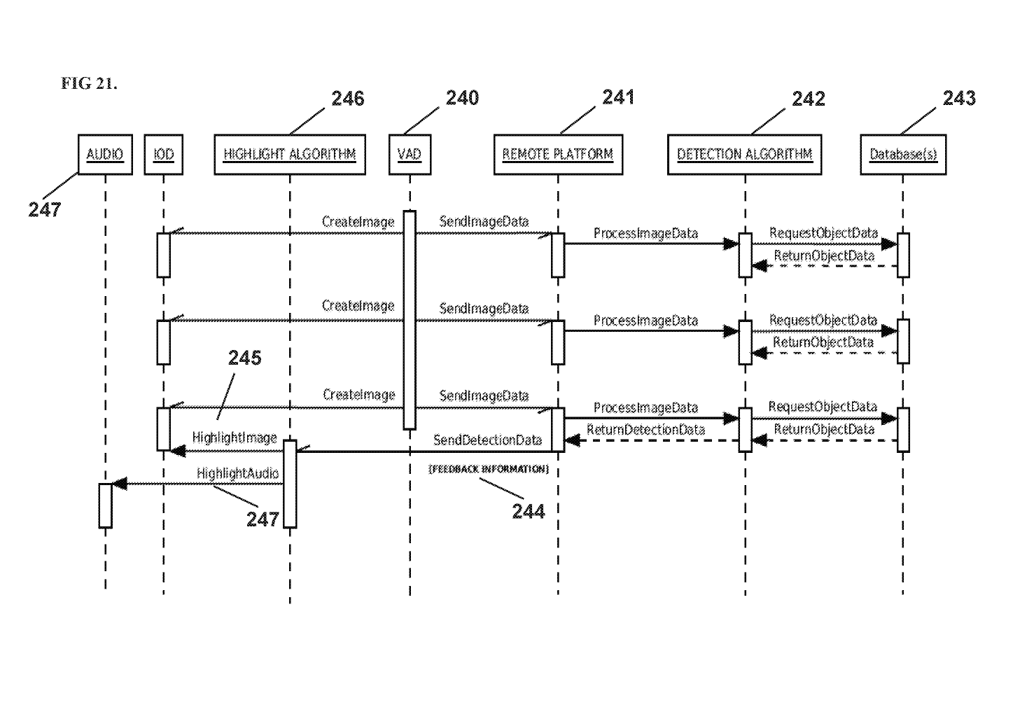

Referring to FIG. 21, in another embodiment, the VAD 240 captures image data via its digital camera. Using software (e.g., streaming software) to transmit images from the controller to a remote platform 241, the image data is processed by a Detection Algorithm 242 on the remote platform 241. The Detection Algorithm 242, among other operations, compares the image content against data stored in a Database 243. The results of the comparisons are returned to the VAD 240 via streaming software from the remote platform 241. In some cases, no object is detected in the image. In other cases, there is a detected object. When an identified object is detected, the VAD 240 will provide some feedback 244 to the user. The feedback can be processed by a Highlight Algorithm 246, which can include highlighting 245a section of the image-based stimulation pattern to draw the user's attention to the detected object. Additionally, the VAD 240 can use an audio indication 247 to alert the user that an object has been detected. Either, both, or some other means can be used to provide feedback information 244 to the user in the event of an object detection event.

In one embodiment, the landmark detection operation is coupled with Shadow-Removal, as described herein, so that signs occluded by a shadow can be detected.

Empirical data generated during development of embodiments of the invention identified a shortcoming of a VAD 100 according to the invention. In particular, it was determined that the distance that signs of interest were detectable was approximately 7 m, and in practice, a user reliably used the device to detected signs at 3-4 m, due to pixel density limitations of the camera/imaging system. Specifically, this limitation was due to the pixel density of the imaging system, which for VAD 100 means that beyond 7 m, the height of a sign in the image was just 2-3 pixels (or fewer). Thus, it was difficult to detect. Accordingly, additional experiments conducted during development of embodiments of the invention addressed this problem by using a camera with higher pixel density and/or by implementing a pixel augmentation algorithm that enhanced the pixel density at a longer range (e.g., greater than 7 m, greater than 8 m, greater than 9 m, greater than 10 m, greater than 15 m, greater than 20 m, greater than 25 m, greater than 30 m, greater than 35 m, greater than 40 m, greater than 45 m, or greater than 50 m). Thus, by using a camera with higher pixel density and/or the pixel augmentation algorithm, the range at which landmarks can be detected is increased. In another embodiment, when a landmark is detected, software (e.g., SOM or Remote) is configured to take special action to improve the accuracy of detections. For example, in one embodiment, upon detection, the camera is commanded to ‘zoom in’ to the detected location, and/or the camera is commanded to increase the image resolution.

Referring to FIG. 22, in another embodiment, the VAD captures image data via its digital camera and processes the image data using a Detection Algorithm 250. As shown the process begins in step 251 wherein detection data is received wherein the process proceeds to step 252 wherein landmark coordinates which locate the landmark (e.g., via GPS coordinates) in the image are extracted wherein the process proceeds to step 253 wherein the landmark coordinates are used by the VAD to adjust the camera parameters which include but are not limited to digitally and/or optically zooming to the landmark location, wherein the process proceeds to step 254 wherein camera parameters can be adjusted to increase the image resolution by increasing the number of image pixels used during image acquisition.

Shadow Detection and Elimination. When using a VAD 100 of the invention, shadows in the image scene may confuse the blind user since the user may have difficulty determining if the lack of stimulation (e.g., based on luminance) is because there's a hole or other object absorbing light, or if there's a shadow cast by an object. Therefore, the invention provides methods and systems to detect and reduce and/or eliminate shadows in an image stream (e.g., to improve visual information relayed to and/or perceived by the user). For example, in one embodiment, using a camera 10 of the VAD 100, a digital image stream is examined (e.g., by software and/or hardware algorithm present in the VAD 100 controller 8 and/or located on a remote platform) to detect shadow-like features in the image scene. In one embodiment, if a shadow-like feature is located in the camera field of view, a shadow-removal algorithm is applied to the suspect region (e.g., thereby allowing a user to experience and/or evaluate their environment/scene without the shadow; alternatively, if the VAD 100 determines that the shadow-like region is not a shadow, the VAD 100 provides the user information regarding the shadow-like feature in the field of view (e.g., thereby allowing the user to avoid the shadow-like feature (e.g., object)).

The invention is not limited by the method of removing shadow(s) from the visual information captured by the camera. In one embodiment, shadow detection and removal from visual information captured by the camera (e.g., the digital image stream) includes processing of the visual information by the headset controller and/or the remote platform (e.g., using a processor, algorithm, and/or other computer component) to remove shadows from the visual information (e.g., prior to providing feedback regarding the visual information captured by the camera (e.g., the digital image stream) to a blind person via the headset). For example, when a shadow-like feature is detected, a shadow-removal algorithm is applied to the region to first determine whether the feature is or is not a shadow. If a shadow is detected, the shadow-removal algorithm will update the image to replace the shadow with indicators of scene features in the field of view hidden by the shadow. In one embodiment, the shadow-removal algorithm will create a 2-dimensional distance map of objects in the shadow region. The distance map is used to generate stimulation patterns of the shape of objects in the shadow region, where closer distance points have a stimulation intensity different from distant points in the shadow region, the pattern being merged with the luminance data stimulation patterns to create a unified stimulation pattern representative of the objects in the camera scene (e.g., thereby effectively removing the shadow from the scene). The distance map can be created using an active transducer such as a light-based (e.g., of any wavelength) time-of-flight range sensor to return the distance of objects in the shadow location, an ultrasonic range finder, or any other device or technique used to determine the distance of objects from the point of view of the user.

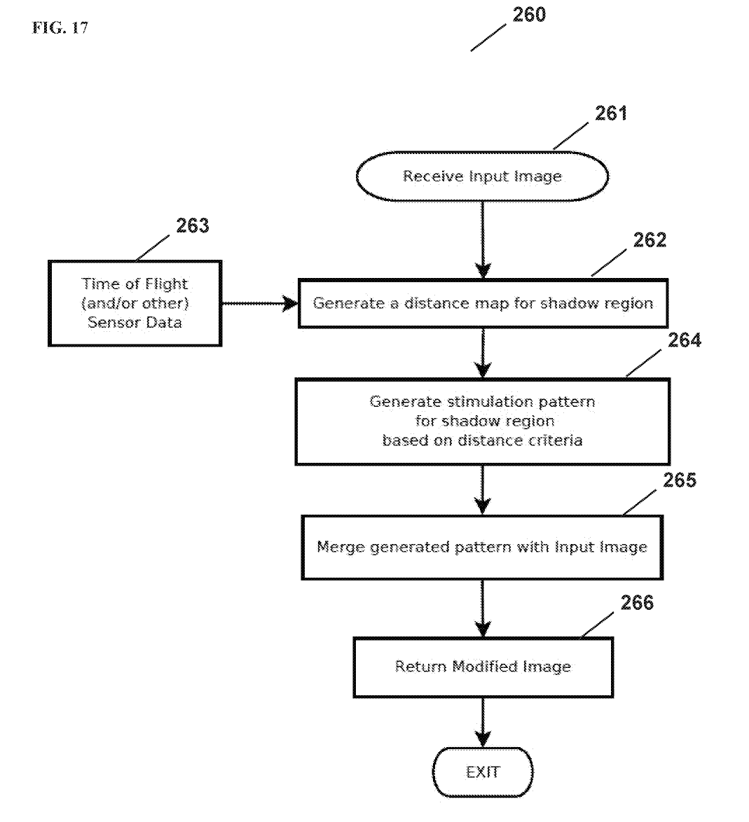

For example, referring to FIG. 17, there is depicted an exemplary flow chart 260 for a VAD receiving image data according to an embodiment of the invention. As shown the process begins in step 261 with the VAD receiving image information (e.g., image data captured by a camera) wherein the process proceeds to step 262 wherein a distance map for the shadow region is created using data from a Time-of-Flight and/or other Sensor 263 wherein the distance map indicates the distance from the user of an object in the shadow region wherein the process proceeds to step 264 wherein the distance map for the shadow region is used to create a shadow stimulation pattern for the shadow region wherein the shadow stimulation pattern is representative of the differences in distance (for example, stronger stimulation for nearer objects, less stimulation for more distant objects) wherein the process proceeds to step 265 wherein the shadow stimulation pattern is merged (e.g., added, overlaid, or otherwise combined) with the input image at the shadow region location and wherein the process proceeds to step 266 wherein the modified image is returned to the VAD.

In one embodiment, a shadow removal algorithm is executed locally (e.g., on the VAD 100 by the VAD 100 controller 8). In another embodiment, a shadow removal algorithm is executed remotely (e.g., on a remote platform (e.g., on a smart phone, tablet, PC, or similar device (e.g., using WiFi or other wireless or wired connection). In one embodiment, a shadow removal algorithm is executed both local (e.g., by the VAD 100 controller 8) and remotely (e.g., on a remote platform). For remote execution, a data exchange protocol is used between the VAD 100 and the remote platform.

In one embodiment, a VAD 100 of the invention includes a Headset 1 Motion Tracking Unit (MTU) that monitors user data (e.g., movement, location, orientation, etc.). In one embodiment, the user data is used to correlate temporally-sequential images (e.g., to emulate parallax achieved by using multiple cameras). Thus, in one embodiment, scene features that are dependent on lighting (e.g., direction of the lighting) are identified and appropriately classified as shadows or not shadows. In an alternate embodiment, a headset 1 of the VAD 100 includes two or more cameras 10 thereby allowing direct computation of parallax disparity from corresponding image scenes. In another embedment, together with or in addition to software/hardware algorithms, an active transducer is coupled to and synchronized with the VAD 100 camera 10 image stream to detect features in a shadow-region. In one embodiment, the active transducers include, but are not limited to, a light-based (e.g., of any wavelength) time-of-flight range sensor (e.g., a single point, imaging array, etc.) and/or an ultrasonic range finder.

Obstacle Detection and Collision Avoidance. In one embodiment, a user of a VAD of the invention learns to interpret the stimulation patterns presented to the tongue. This interpretation task takes time, which can be improved by practice and/or instruction. In one embodiment, a VAD of the invention provides detection of obstacles thereby assisting a user to avoid collisions and/or helping to reduce the interpretation burden for the user. For example, in one embodiment, using a camera of the VAD, the digital image stream is examined (e.g., by software and/or hardware algorithm) to infer whether an obstacle is in the pathway of the user. In one embodiment, if an obstacle is in the camera field of view, the user is alerted by one or more means (e.g., audio means or haptic means). In one embodiment, a Region of Interest (ROI) which encompasses the image area containing the obstacle is used to highlight the corresponding region on the tongue display, thereby assisting the user to avoid said obstacle. In another embodiment, an obstacle detection algorithm is executed locally (e.g., on the VAD) and/or remotely (e.g., on a remote platform (e.g., on a smart phone, tablet, PC, or similar device (e.g., using WiFi or other wireless or wired connection))). For remote execution, a data exchange protocol is used between the VAD and remote platform.

In a further embodiment, separately or in combination with software/hardware algorithms, a Headset Motion Tracking Unit (MTU) is used to monitor user data (e.g., to assist in identifying and avoiding collision with objects. In another embodiment, in addition to software/hardware algorithms, an active transducer is coupled to and synchronized with the VAD camera image stream to directly detect an object in the field of view of the camera and near to its user (e.g., by determining the distance of an object from the user). Exemplary active transducers include but are not limited to light-based (of any wavelength) time-of-flight range sensor (e.g., single point, imaging array, etc.) and ultrasonic range finders.

Crosswalk Assistant. In one embodiment, the invention provides a VAD and methods of using the same to assist a blind user identify a crosswalk and/or in crossing a street controlled by traffic and/or pedestrian signals. For example, in one embodiment, using a VAD of the invention, a user enters “Crosswalk Mode’ and once activated, the VAD user points the camera towards an area where a traffic signal is thought to be. Using video image stream captured by the camera of the VAD, a connected mobile app (e.g., located on a remote platform or run locally on the VAD controller) locates the signal in the image field and sends feedback to the user to help keep the signal centered in the image. In one embodiment, the mobile application analyzes the image (e.g., to determine if the signal indicates that crossing is permitted) and instructs the user (e.g., provides guidance to the user) regarding the status of the crosswalk. In the case of sign detection processing taking place on a remote platform, the structured detection data is securely transmitted to the VAD via a wireless network connection as described herein. The VAD will process and apply the detection information upon successful receipt of the data.

Range Detection and Filtering. In one embodiment, when using a VAD of the invention, the 3-dimensional world is captured by a 2-D image sensor with image processing handled as 2-dimensional data. Under these circumstances, depth or distance information is hard to achieve by the blind user. Thus, the present invention provides methods and apparatus for implementing a means for the user to determine the distance to objects. In addition to distance detection and reporting, a user may filter image databased on distance in order to reduce the amount of non-useful information (e.g., eliminate any objects more than 20 ft. away (e.g., thereby allowing a closer analysis of information within the set distance (e.g., identification of obstacles within the set distance)).

Color Detection. With grayscale images derived from luminance data, the blind user cannot identify colors even though the original camera data is in color. In addition, the current stimulation waveforms use a fixed pattern (pulse frequency) to present the luminance data to a user's tongue. Thus, in one embodiment, the present invention provides a VAD that assigns a unique waveform pattern to specific colors, thereby allowing the user to the feel a different sensation for each color (e.g., allowing the user to associate a particular, unique sensation to a particular color).

Contrast Detection. It has been noted that in grayscale images derived from luminance data, features with same contrast are indistinguishable by a blind user. Thus, in one embodiment, the present invention provides a VAD that, by using color images from a camera and applying a filter to those images (e.g., edge enhancement) then overlaying (adding) the filtered data to the luminance data, features with the same contrast are distinguishable by the user.

Gesture-based Control. In one embodiment, the present invention provides a VAD that, by monitoring MTU data, software on either the Torpedo SOM or a remote platform connected device can determine the motion of the headset. In one embodiment, in a user selected mode, “MTU Gesture Control”, the unit will respond to certain body movements by adjusting settings. For example, in Gesture Control mode, leaning forward has the effect of ‘zooming in’ the camera field of view, effectively making the objects in a scene look larger. Leaning backwards has the opposite effect, ‘zooming out’. The lean rate and angle can affect the magnitude of the zoom action.

In one embodiment, similar Gesture Control actions are used for any parameter that can be set by the user. In addition to leaning, gesture movements include turning or bending the head(set), bouncing/hopping, etc. In addition, in “Hand Gesture Control” mode, software on either the Torpedo SOM or a remotely connected platform can examine the camera image data to detect hand motion and interpret the motions as user inputs to adjust parameters. For example, in Gesture Control mode, moving a hand from the bottom of the camera field of view to the top could increase the stimulation intensity. The speed of hand motion could affect the rate of change of the parameter. Similar Gesture Control actions could be used for any parameter that can be set by the user. In one embodiment, Hand Gesture Control is used separately from MTU gesture control. In another embodiment, Hand and MTU Gesture Control are used concurrently.

In a another embodiment, the invention provides use of a hand gesture control to activate one or more electrodes on the intraoral device. For example, a hand gestures can be used as a training tool for the user to detect and sense (e.g., via electrotactile stimulation of the tongue) letters, shapes, or other objects identified by hand gestures and recognized by the systems of the invention. In one embodiment, a hand gesture recognition is used to assist a user to learn letters or objects (e.g., iconic languages (e.g., Chinese)) via having the subject trace a letter or object and having the hand gesture detected, processed and fed-back to the user via haptic and/or audible means. In one embodiment, a system of the invention activates electrodes on the IOD to represent on the user's tongue the a letter or object that is being traced by the user (e.g., a user uses his or her finger to trace a letter or object and “sees” the letter or object on their tongue). In one embodiment, a system of the invention guides the user when learning to trace a letter or object via activation of electrodes on the IOD (e.g., the system is programmed to activate electrodes as the user moves his/her finger in correct direction, shape or way when tracing a letter or object (e.g., thereby assisting the user to learn what the shape or object looks like (e.g., a system of the invention is used as a training tool)).

In another embodiment, a VAD of the invention includes a remote platform and a touch screen (e.g., on a tablet, smartphone, etc.) and means of representing the IOD electrode array on the touch screen (e.g., software is executed by the VAD to display the IOD electrode array on the touch screen). In a further embodiment, as a user touches an electrode location on the screen, the corresponding electrode on the IOD is activated (e.g., with intensity based on pressure of the touch, or, with a preset intensity). As the user moves her/his finger around the touchscreen (e.g., touching additional electrodes), the corresponding electrodes activate on the IOD. In one embodiment, the activated electrode has a persistence such that it remains activated for a period of time (e.g., a selectable and/or programmed amount of time (e.g., milliseconds, a second or two, several seconds, 10, 20, 30, 40, 50, 60 or more seconds, or until the user deactivates the signal). Accordingly, the invention provides, in one embodiment, a VAD useful for a blind user to learn to draw letters and/or objects/shapes, and/or to play games (e.g., games that provide a user with knowledge of the appearance of letters, shapes and/or objects). In another embodiment, and as described above, instead of a touch screen, a VAD of the invention includes a Gesture Base control system that provides a user the ability to stimulate electrodes on an IOD worn by the user as the user moves his/her hand through space in front of the camera (e.g., that allow a user to learn to draw letters and/or objects/shapes, and/or to play games (e.g., games that provide a user with knowledge of the appearance of letters, shapes and/or objects)).

In one embodiment, software is configured to run independently of other software. In other embodiments, software is configured to run within or together with other software including, but not limited to, WINDOWS (e.g., WINDOWS 10 (or earlier iteration), or other WINDOWS based operating system), JAVA, cell phone operating systems, or other type of software. In some embodiments, visual information and/or data is collected, recorded and/or stored locally (e.g., by the controller located in the headset) or remotely (e.g., on a remote platform). In one embodiment, stored visual information is utilized by the same user from which the stored visual information originated. In another embodiment, stored visual information is utilized by a different user from which the stored visual information originated. In one embodiment, stored information is communicated to a software configured to track and/or manage such information (e.g., via the internet, the cloud, or other wireless communication (e.g., via BLUETOOTH, ZIGBEE, infrared, FM, AM, cellular, WIMAX, WIFI, or other type of wireless technology). In one embodiment, information and/or data collected, recorded and/or stored by a VAD of the present invention is made available over a network (e.g., TCP/IP, SANS, ZIGBEE, wireless, wired, USB, and/or other type of network) or via mobile information recording devices (e.g., flash card, memory stick, disc, jump drive, etc.). In one embodiment, a network is configured to comply with certain government protocols and/or regulations. In one embodiment, software configured to interact with a VAD of the present invention comprises a mobile resource for a VAD user in the field. For example, in some embodiments, software is configured to provide a user of a VAD of the present invention a variety of information including, but not limited to, location, surrounding landmarks, landmarks within the user's field of view, GPS coordinates, weather, traffic conditions, known obstacles within a user's field of view, or other types of information.

Software on the remote platform may access local and Internet databases, in combination with VAD information, to provide enhanced object placement in a scene. In the case of landmark detection processing taking place on a remote platform, the structured detection data can be securely transmitted to the VAD via a wireless network connection. The VAD will process and apply the detection information upon successful receipt of the data.

Experiments were conducted during development of embodiments of the invention in order to test and characterize systems, methods, and algorithms generated for detecting signs. In particular, systems and methods of the invention were used and implemented to test the ability to detect signs, for example, Exit signs and Men's and Women's Restroom signs. The systems and methods tested utilized algorithms implemented using standard libraries in both a desktop environment as well as ported to a tablet (e.g., ANDROID tablet), using either streaming video/images from a remote video feed (e.g., from the VAD or streamed from the internet) or a video feed from the controller (e.g., a camera housed within the controller (e.g., tablet, smartphone, etc.)).

Detection Algorithm. The sign detection algorithm was based on a sliding window approach (See, e.g., Wei and Tao, 2010 IEEE Conference on, 13-18 Jun. 2010, pp. 3003-3010), in which a small window is translated (e.g., “slid”) over the entire image. For each type of target sign to be detected, the corresponding sliding window has a fixed aspect ratio, and multiple scales were used to capture the signs at different apparent sizes in the image. For example, as non-limiting examples, for an Exit sign, these windows ranged in size from 18×12 to 216×144 pixels, while for the Restroom sign the size ranged from 12×32 to 120×320 pixels. Each image patch was converted to a visual descriptor (See, e.g., Freund and Schapire, Journal of Computer and System Sciences, 55(1), 1997, pp. 119-139) which was fed into a classifier that determined whether an image patch was classified as either containing a sign of interest or not. Searches were performed over multiple scales to accommodate a range of viewing distances (e.g., with adjacent scales separated by a factor of 1.5). This resulted in roughly ˜10⁵ candidate image patches for each image that were classified as SIGN or NO SIGN.

The overall classifier for each patch was based on a cascade of filters in a boosting paradigm (See, e.g., Hastie et al., The Elements of Statistical Learning, 2nd ed. Springer, 2009; Schapire and Singer, Machine Learning, 1999, pp. 80-91) with filters in each stage removing patches from subsequent consideration if they were classified as non-signs; at each successive layer fewer image patches needed to be analyzed. At the end, a more discriminative (e.g., a more computationally intensive) classifier was used to make a final SIGN/NO SIGN decision on the remaining candidate image patches, typically much fewer in number (e.g., a few tens of candidates per image).

Different Types of Signs. The VAD, methods and algorithms utilized detected Exit signs and Men's and Women's Restroom signs upon a user selecting what type of sign the user wanted to detect. However, and as described in detail herein, the invention is not limited to Exit signs and Men's and Women's Restroom signs. In fact, the systems, methods and algorithms described herein may be used to detect any type of landmark desired. Furthermore, it is also possible to utilize systems, methods and algorithms in order to simultaneously detect multiple types of signs (e.g., 1, 2, 3, 4, 5, 10, 15, 20, 25, 50, 100 or more different types of signs (e.g., if desired by the user (e.g., the user may wish to be informed whenever an Exit sign or a Restroom sign of specific gender is detected))). When systems are configured to detect multiple types of signs, additional computations (e.g., additional computational processing bandwidth and power consumption) are needed. Thus, in one embodiment, having separate modes for each sign reduces the computational load thereby enabling real-time performance and improved responsiveness and potentially also prolonging a VAD's (e.g., a tablet's) battery life. However, in another embodiment, when systems of the invention are configured to concurrently detect multiple types of signs, the additional computations (e.g., additional computational processing bandwidth and power consumption) are performed on a remote processor (e.g., accessible via connection (e.g., wireless connection) to a server/processor accessible over the internet). Having the additional computations performed on a remote server reduces the computational load on the VAD itself, thereby enabling real-time performance and improved responsiveness and prolonging a VAD's (e.g., a tablet's) battery life.

First Stage Classifier. The first stage cascade used a Gentle Adaboost (See, e.g., Schapire and Robert. Nonlinear estimation and classification. Springer New York, 2003, pp. 149-171) classifier using Local Binary Pattern (LBP) descriptors (See, e.g., Ojala, et al., Proceedings of the 12th IAPR International Conference on Pattern Recognition (ICPR), 1994, vol. 1, pp. 582-585; Wang et al., International Conference on Computer Vision (ICCV), 2009) to describe an image. Implementation of the cascade classifier used OpenCV's implementation, which uses a set of simple decision tree classifiers as weak classifiers, and combines them to learn a single strong classifier that is trained to minimize the number of actual signs that are missed, sacrificing precision (e.g., possibly including some non-sign patches) to achieve this high recall rate. This ensured that the SIGN of interest was not eliminated at this stage, but was passed on to the next stage which is responsible for finding it (e.g., if it exists) among the remaining detections.

Typically a single target in the image will give rise to multiple detections at similar locations and with similar sizes, since the Adaboost classifier is robust to small translations and size changes of the target in the sliding window. Since these multiple detections are redundant, a clustering step was implemented at the end of the first stage which identified clusters of rectangles with similar location and size and selected only a single detection candidate (e.g., rectangle) from each cluster. This reduced the number of detection candidates that have to be processed in the second stage classifier, which was more selective but also more computationally intensive.

Second Stage Classifier. At the output of the first stage cascade classifier, the number of candidates was reduced to around a few tens per image. The second layer of the cascade used the Histogram of Oriented Gradients (HoG) (See, e.g., Dalal and Triggs, IEEE Computer Society Conference, 2005, vol. 1, pp. 886-893) as a visual descriptor, which complemented the LBP descriptors used in the first layer. Note that HoG was too computationally intensive to apply to all ˜10⁵ original image patches (e.g., which were analyzed by the first layer of the cascade), but the first layer filtered out the great majority of these patches. This descriptor was used as input into a support vector machine (SVM) with an RBF Kernel (See, e.g., Cristianini and Shawe-Taylor, Intelligent Data Analysis, M. Berthold and D. J. Hand, Eds. Springer Berlin Heidelberg, 2007, pp. 169-197.

The SVM layer classified all remaining patches as SIGN or NO SIGN. Each classification was also assigned a confidence value between 0 and 1 corresponding to the likelihood of the patch being a SIGN, with 1 being very likely and 0 being very unlikely. Among the patches that were classified as containing the SIGN of interest, only the ones whose likelihood exceeded a set threshold were returned. If no patch was classified as SIGN with a confidence higher than this threshold, no detection was reported. For example, the basic Restroom sign detector responded equally to Men's and Women's signs, but an additional processing stage was used to distinguish between Men's and Women's; a second and final SVM layer was applied after a Restroom sign had been detected in order to determine whether it was a Men's or Women's sign.

Tracking. No detection algorithm is perfectly reliable, which means that in some frames a valid target sign may not be detected, while spurious detections may occur in other frames. In addition, detection performance was often compromised by camera motion blur, which can occur any time the camera is moved, and is especially problematic under low light conditions (e.g., indoor environments). These problems posed a challenge to the development of an effective sign recognition system, in combination with the VAD systems and methods described herein, that were usable by blind and visually impaired persons (e.g., that require coherent information about the presence and location of each target of interest).

In order to address and overcome these issues, in one embodiment, a temporal integration stage was applied (e.g., such as motion tracking) after the classifier stages. For example, means of combining static appearance cues (e.g., obtained using the classifiers in individual video frames) with motion cues (e.g., obtained by integrating information over multiple video frames) were tested. In the end, motion tracking was used to combine static appearance cues with motion cues, however, any other means of combining static appearance cues with motion cues known in the art also finds use in the invention. Thus, in one embodiment, a motion tracking algorithm was implemented. The motion of each candidate was tracked and verified via optical flow through consecutive frames, and a valid SIGN was only announced after consistent detections (e.g., from the classifier) in three out of the next fifteen consecutive video frames (e.g., corresponding to roughly a half-second verification delay for a thirty frame per second video). The choice of this parameter was done heuristically; a less strict criterion (e.g., require two out of every fifteen frames) will reduce delay (which may be preferable in low frame rates), and a more strict criterion (e.g. require three out of every ten frames) will reduce false positives at the expense of more delay.

The target was then tracked in subsequent frames, in which the static appearance-based criteria for selecting target candidates based on the classifiers were relaxed (e.g., allowing the possibility of tracking a target that temporarily becomes harder to resolve because of motion blur); for example, the system was configured such that it required that only one other successful validation of the SIGN occur every 10 frames (e.g., although the parameters could be adjusted for any resolution environment). If the SIGN was not validated for 10 consecutive frames of tracking, then this target was deleted from the tracker.

Thus, in some embodiments, the tracking algorithm had the effect of smoothing out false positives (e.g., spurious detections) and false negatives (e.g., missed detections) that occur with the classifiers. In another embodiment, it also allowed for multiple targets to be tracked at the same time. Furthermore, in one embodiment, by locking on to a target, a user was only alerted to each SIGN once upon detection (e.g., thereby reducing potential confusion by a blind user (e.g., under conditions where it may not be clear to the user that the detections correspond to the same object)).

The systems, methods and algorithms described herein were tested and demonstrated successfully how the tracking algorithm smoothed out noisy detections in an Exit sign detection experiment. The detection experiments and processes were attempted both with and without tracking turned on. When tracking was turned off, there were many false negatives (e.g., missed detections) even when the Exit sign was clearly resolved by a video capture device (e.g., a video camera of the VAD). In sharp contrast, with tracking turned on, the Exit sign was detected continuously after a brief delay while the tracker acquired a lock on the target. Thus, in one embodiment, the invention provides a VAD comprising hardware and an algorithm that allows a blind or visually impaired person to track a target (e.g., track continuously while the target remains in view (e.g., of the VAD camera), thereby significantly increasing the accuracy of the location estimate provided).

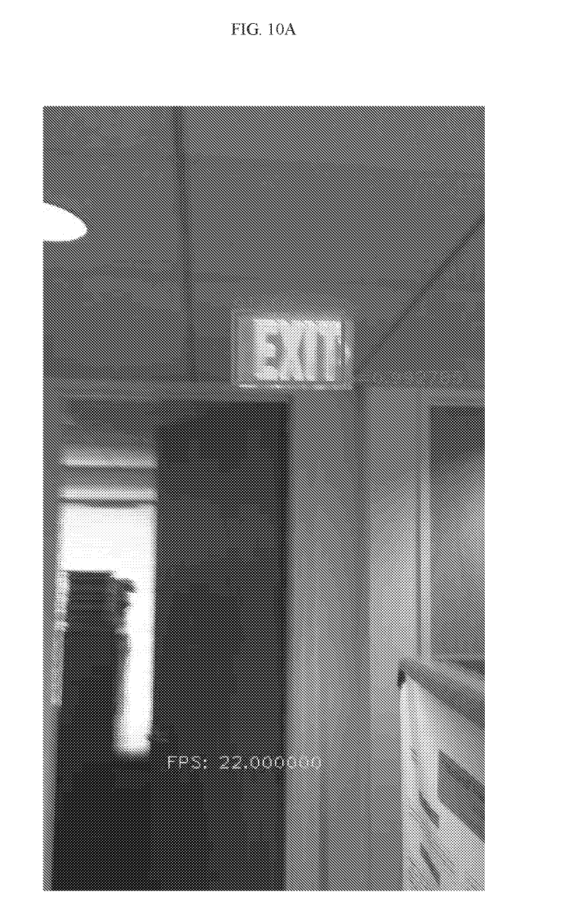

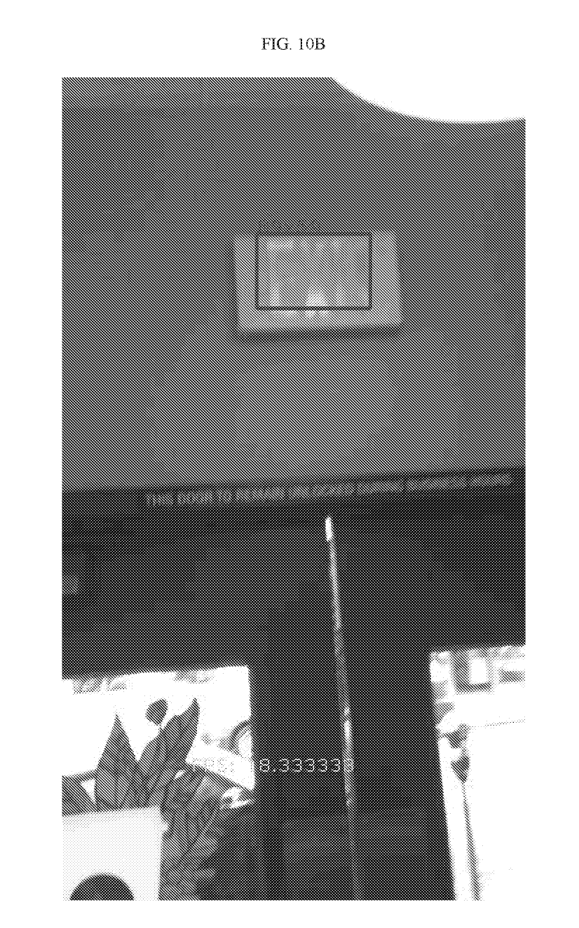

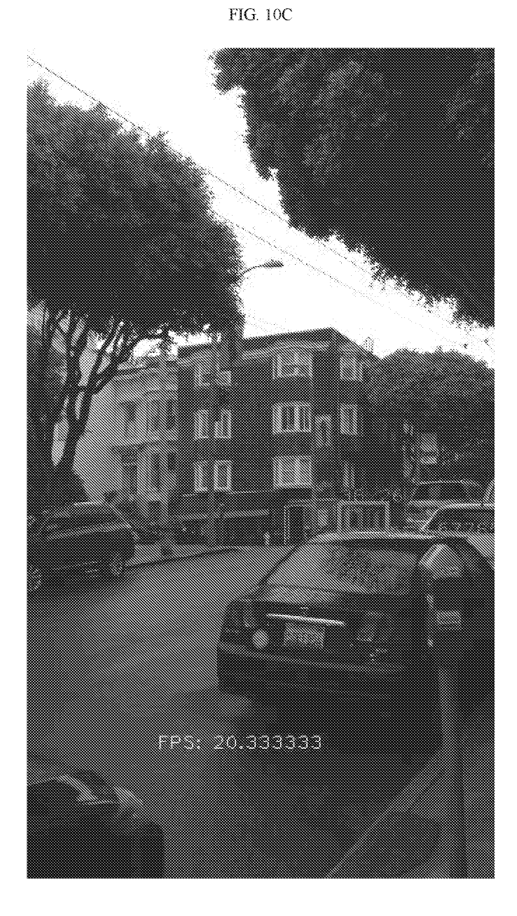

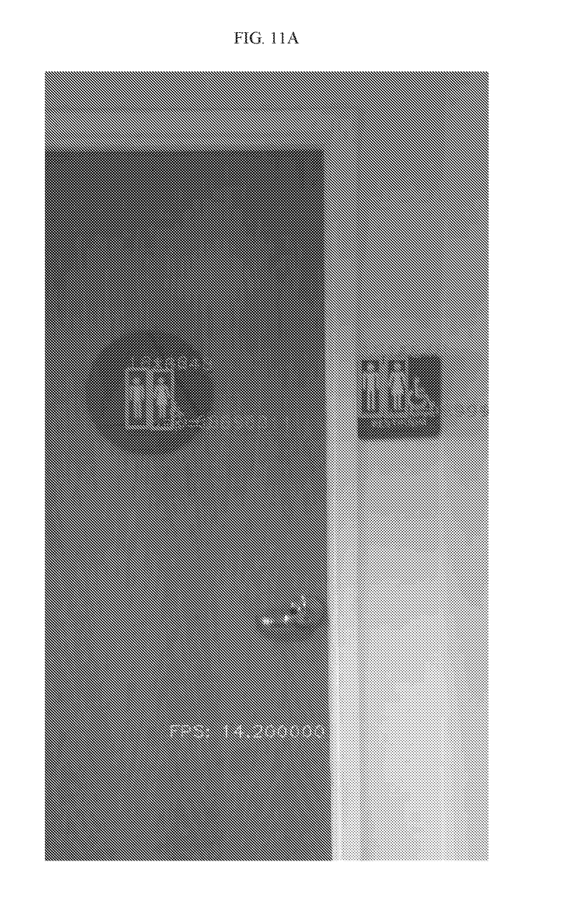

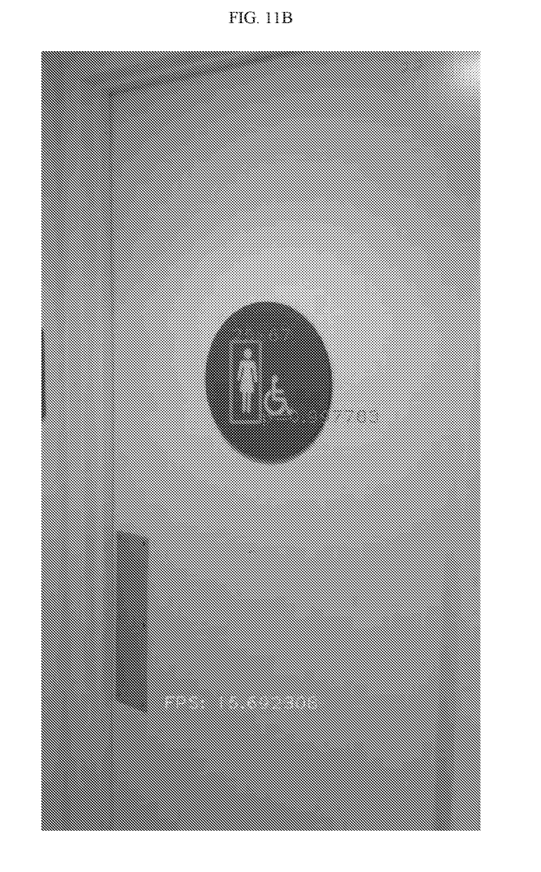

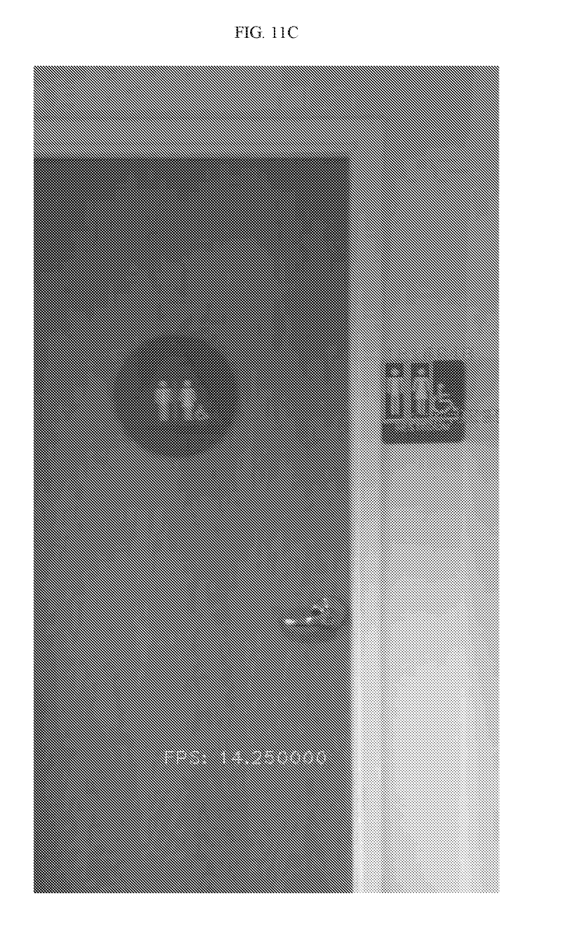

FIGS. 10 and 11 show sample detections in images captured, as well as some missed and false detections. The missed detection shown in FIG. 10B (rectangle) is an example of a sign that was correctly captured by the first classifier stage (Adaboost) but incorrectly captured by the second classifier stage (SVM). While only partial appearance-based evidence may be available for a sign in a particular image, motion continuity cues (e.g., employed in a tracking algorithm) are used to boost the evidence for such a sign and result in an overall successful detection.

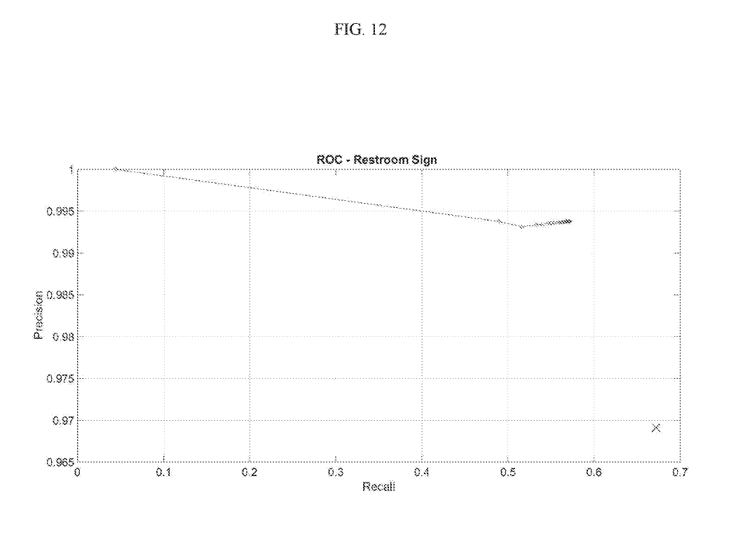

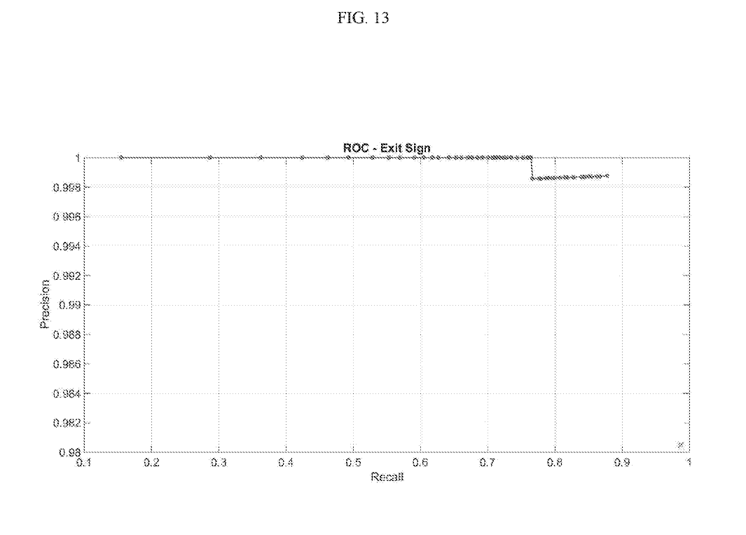

Systems and methods, including algorithm performance, were measured objectively using an ROC curve that shows how precision and recall can be traded off each other. As used herein, “precision” refers to the fraction of detections that are correct, while “recall” refers to the fraction of signs that are detected. Performance results using the tracker compared with when the tracker was turned off are shown in FIGS. 12 and 13. Recall and precision calculations measured the performance of the entire detector (Restroom or Exit), using video feeds that were separate from the imagery that was used to train the detectors.

Thus, in one embodiment, the invention provides a VAD system and method for sign detection. In one embodiment, a user uses a VAD system and method together with an application (app (e.g., a windows app, a MAC app, or other operating system app described herein) to detect a landmark (e.g., a sign). In one embodiment, the app, upon launch, allows a user to turn a tracking function of the VAD system on or off. Subsequently, the user is able to choose the video source (e.g., a remote video feed (e.g., from the VAD or streamed from the internet) or a video feed from the controller (e.g., a camera housed within the controller (e.g., tablet, smartphone, etc.))). The user can then choose target acquisition mode (e.g., chooses a specific type of target to search for (e.g., an Exit or Restroom sign), or, choose to search for and acquire a plurality of targets). In one embodiment, each detection is highlighted (e.g., shown as a rectangle (e.g., highlighted in a specific color)) and superimposed on the raw video image (e.g., acquired at VGA resolution). The invention is not limited to this type of notification of detection. Indeed, additional means of notifying a user that a desired target (e.g., landmark) has been acquired may be used including those means disclosed herein.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields, are intended to be within the scope of the following claims.

What is claimed is:

1. A system for aiding a blind person comprising:
a) means for obtaining visual information from the person's environment, the means comprising a digital video camera located in a headset worn by the person;
b) means for detecting, identify, and highlighting a landmark in the visual information, wherein the means comprise analysis of the visual information by a processor located in a controller present in the headset and/or by a processor located on a remote platform; and
c) means for providing feedback to the person regarding the visual information, wherein the means comprise haptic means and/or audible means.

2. The system of claim 1, wherein the controller present in the headset communicates with the remote platform via a wireless network.

3. The system of claim 1, wherein the controller present in the headset communicates with the remote platform via a wired network.

4. The system of claim 1, wherein the landmark is a sign.

5. The system of claim 4, wherein the sign is a sign selected from the group consisting of an exit sign and a restroom sign.

6. The system of claim 1, wherein the landmark is a crosswalk.

7. The system of claim 1, wherein a processor on a remote platform executes software that analyzes the video information in order to detect the presence or absence of the landmark.

8. The system of claim 1, wherein a processor in the headset executes software that analyzes the video information in order to detect the presence or absence of the landmark.

9. The system of claim 1, wherein feedback is provided to the person in the form of electrotactile stimulation of the person's tongue via an intraoral device.

10. The system of claim 1, wherein the headset further comprises a speaker or headphone jack.

11. The system of claim 10, wherein feedback is provided to the person via the speaker and electrotactile stimulation of via an intraoral device.

12. The system of claim 11, wherein the feedback allows the person to detect, identify, and/or move towards a landmark while concurrently navigating around, over, and/or through obstacles or structures between the person and the landmark.

13. The system of claim 12, wherein the landmark is highlighted on the person's tongue using electrotactile stimulation.

14. The system of claim 13, wherein shadows are removed from the visual information by an algorithm run on the remote platform.

15. A method for a blind user to detect, identify and move towards a landmark comprising the steps of:
a. providing a means for obtaining visual information from the person's environment, the means comprising a digital video camera located in a headset worn by the user;
b) detecting, identify, and highlighting a landmark in the visual information through analysis of the visual information by a processor located in a controller present in the headset and/or by a processor located on a remote platform; and
c) means for providing feedback to the person regarding the visual information, wherein the means comprise haptic means and/or audible means.

16. A system for aiding a blind person to learn letters and/or shapes comprising:
a) means for obtaining visual information from the person's environment, the means comprising a digital video camera located in a headset worn by the person;
b) means for detecting and identifying motion of the headset and/or determining when to process information in the field of view of the headset, wherein the means comprise analysis of the motion information by a processor located in a controller present in the headset and/or by a processor located on a remote platform; and
c) means for providing feedback to the person regarding the visual information, wherein the means comprise haptic means and/or audible means.

17. The system of claim 16, wherein the means for detecting and identifying motion of the headset comprises a motion tracking unit (MTU).

18. The system of claim 16, wherein the MTU comprises a 3-Axis Accelerometer, 3-Axis Gyroscope, 3-Axis Magnetometer and/or a temperature sensor.

19. The system of claim 16, further comprising an active transducer selected from a light-based time-of-flight range sensor and ultrasonic range finders.

20. The system of claim 16, wherein the visual information from the person's environment comprises hand gestures.

21. The system of claim 20, wherein the system detects the hand gestures and provides information regarding the hand gestures to the user via haptic means and/or audible means.

22. A method comprising processing image data relating to an object with a microprocessor to identify the object within the image data; processing the image data with the microprocessor to detect edges of the object, wherein stimulation intensity values are assigned to edge locations in the image data; and wherein an edge enhanced image is made available as a stimulation pattern presented on an array of electrodes for tongue stimulation.

23. The method of claim 22, wherein the edge enhanced image is overlayed the received image data.

24. The method of claim 22, wherein the edge enhanced image replaces the received image data.

25. The method of claim 22, wherein the image data relating to an object is captured by a digital camera.
